(19) United States
(12) Patent Application Publication
(10) Pub. No.: US 2013/0173925 A1
(43) Pub. Date: Jul. 4, 2013

(54) Systems and Methods for Fingerprint-Based Operations

(71) Applicants: Ester Yen, Brentwood, CA (US); Hsushen Kao, New Taipei City (TW); Ling-Yi Hu, Hsinchu City (TW); Chun-Fu Chuang, Taipei City (TW)

(72) Inventors: Ester Yen, Brentwood, CA (US); Hsushen Kao, New Taipei City (TW); Ling-Yi Hu, Hsinchu City (TW); Chun-Fu Chuang, Taipei City (TW)

(21) Appl. No.: 13/368,246

(22) Filed: Feb. 7, 2012

Related U.S. Application Data
(60) Provisional application No. 61/581,016, filed on Dec. 28, 2011.

(51) Int. Cl. G06K 9/00; G06F 21/00

(52) U.S. Cl. 713/186; 382/124

(57) ABSTRACT

A method for operating a system based on fingerprint scanning inputs includes receiving, by a fingerprint sensor, a fingerprint input and providing, from a processor coupled with the fingerprint sensor, fingerprint feature data representing features of the fingerprint input. The method also includes executing a first command, by the processor, if comparing the fingerprint feature data with at least a portion of stored fingerprint data results in a first match reflecting that the fingerprint input occurred in a first direction and executing a second command that is different from the first command, by the processor, if comparing the fingerprint feature data with the at least a portion of the stored fingerprint data results in a second match reflecting that the fingerprint input occurred in a second direction.

### RELATED APPLICATION

This application claims the benefit of priority of U.S. Provisional Application No. 61/581,016, filed Dec. 28, 2011, and titled “SYSTEMS AND METHODS FOR IMPLEMENTING FINGERPRINT SCANNING,” the contents of which are herein incorporated by reference in its entirety.

### TECHNICAL FIELD

This disclosure relates to applications or operations based on fingerprint scanning, as well as systems and methods for implementing fingerprint-scanning related applications or operations.

### BACKGROUND

Fingerprint-related technologies and applications have become more and more popular due to their broad applications. Fingerprint verifications, in some embodiments, may provide security for home or office entry control, access to information, access to networks, financial or other transactions, access to devices or vehicles, and identify verification.

One of the many applications of fingerprint recognition is biometric verification. Traditionally, the mechanism of verification is generally limited to comparing an input fingerprint with a target fingerprint and reporting a match or mismatch. Many present applications do not provide other functionalities based on fingerprint verification.

Therefore, it may be desirable to have systems or methods providing operations or applications based on one or more fingerprint inputs.

### SUMMARY

Consistent with the disclosed embodiments, there is provided a method for operating a system based on fingerprint scanning inputs. The method comprises: receiving, by a fingerprint sensor, a fingerprint input; providing, from a processor coupled with the fingerprint sensor, fingerprint feature data representing features of the fingerprint input; executing a first command, by the processor, if comparing the fingerprint feature data with at least a portion of stored fingerprint data results in a first match reflecting that the fingerprint input occurred in a first direction; executing a second command that is different from the first command, by the processor, if comparing the fingerprint feature data with the at least a portion of the stored fingerprint data results in a second match reflecting that the fingerprint input occurred in a second direction; and executing a third command, by the processor, if comparing the fingerprint feature data with the at least a portion of the stored fingerprint data results in a non-match.

Consistent with the disclose embodiments, there is provided a method for enabling fingerprint-based operation of a client device. The method comprises: identifying, by a remote processing device, a fixed code associated with the client device receiving a fingerprint input; identifying, by the remote processing device, a temporary code associated with the client device, the temporary code being provided by one of the client device and the remote processing device; transmitting the temporary code from the remote processing device to the client device if the temporary code is provided by the remote processing device; receiving encrypted fingerprint feature data from the client device, the encrypted fingerprint feature data being reflective of fingerprint feature data representing features of the fingerprint input and having been encoded based on the fixed code and the temporary code; and decoding the encrypted fingerprint feature data using the fixed code and the temporary code.

Consistent with the disclose embodiments, there is provided a method for enabling fingerprint-based operation of a client device. The method comprises: identifying, by a remote processing device, a fixed code associated with the client device receiving a fingerprint input; identifying, by the remote processing device, a temporary code associated with the client device, the temporary code being provided by one of the client device and the remote processing device; transmitting the temporary code from the remote processing device to the client device if the temporary code is provided by the remote processing device; receiving encrypted fingerprint feature data from the client device, the encrypted fingerprint feature data being reflective of fingerprint feature data representing features of the fingerprint input and having been encoded based on the fixed code and the temporary code; and decoding the encrypted fingerprint feature data using the fixed code and the temporary code.

Consistent with the disclosed embodiments, there is provided a system for implementing fingerprint-based operations. The system comprises: an input interface for receiving, by a fingerprint sensor, a fingerprint input; a processor coupled with the input interface, the processor being configured to provide fingerprint feature data representing features of the fingerprint input, the processor further being configured to execute a first command if comparing the fingerprint feature data with at least a portion of stored fingerprint data results in a first match reflecting that the fingerprint input occurred in a first direction and to execute a second command that is different from the first command if comparing the fingerprint feature data with the at least a portion of the stored fingerprint data results in a second match reflecting that the fingerprint input occurred in a second direction; and a storage device coupled with the processor for storing at least one of the fingerprint data, the first command, and the second command.

Consistent with the disclosed embodiments, there is provided a non-transitory computer readable medium. The non-transitory computer readable medium comprises instructions for implementing fingerprint-based operations, wherein the instructions comprising program code, the program code being operable, when executed by a device, to cause the device to perform a method comprising: receiving, by a fingerprint sensor, a fingerprint input; providing, by a processor, fingerprint feature data representing features of the fingerprint input; comparing, by at least one of the processor and a remote processing device, the fingerprint feature data to at least a portion of a stored fingerprint data; executing a first command, by the processor, if the fingerprint feature data being compared result in a first match reflecting that the fingerprint input occurred in a first direction; executing a second command, by the processor, if the fingerprint feature data being compared result in a second match reflecting that the fingerprint input occurred in a second direction; and executing a third command, by the processor, if the fingerprint feature data being compared result in a non-match.

It is to be understood that both the foregoing general description and the following detailed description are exemplary and explanatory only and are not restrictive of the claimed subject matter.

### BRIEF DESCRIPTION OF THE DRAWINGS

The accompanying drawings, which are incorporated in and constitute a part of this specification, illustrate embodiments consistent with the disclosed embodiments and, together with the description, serve to explain the principles of the disclosed embodiments.

FIG. 1 illustrates an exemplary communication and control system based on fingerprint scanning input consistent with the disclosed embodiments.

FIG. 2 illustrates an exemplary block diagram of a portable device consistent with the disclosed embodiments.

FIG. 3 illustrates an exemplary block diagram of a remote processing device consistent with the disclosed embodiments.

FIG. 4 illustrates a flowchart of an exemplary method for an apparatus to execute commands based on fingerprint input direction, consistent with the disclosed embodiments.

FIG. 5 illustrates exemplary fingerprint swipings over an exemplary fingerprint sensor in substantially vertical directions, consistent with the disclosed embodiments.

FIG. 6 illustrates exemplary fingerprint swipings over an exemplary fingerprint sensor in substantially horizontal directions, consistent with the disclosed embodiments.

FIG. 7 illustrates a flowchart of an exemplary method for an apparatus to execute commands based on fingerprint input direction, consistent with the disclosed embodiments.

FIG. 8 illustrates a flowchart of an exemplary method for a portable device to transmit the fingerprint feature data to a remote processing device, consistent with the disclosed embodiments.

FIG. 9 illustrates a flowchart of an exemplary method for a portable device to transmit encoded fingerprint feature data to a remote processing device, for executing commands by the remote processing device based on the received fingerprint features, consistent with the disclosed embodiments.

FIG. 10 illustrates a flowchart of an exemplary method for a portable device to encrypt the fingerprint feature data, consistent with the disclosed embodiments.

FIG. 11 illustrates a flowchart of an exemplary method for a remote processing device to decrypt the fingerprint feature data, consistent with the disclosed embodiments.

FIG. 12 illustrates a flowchart of an exemplary method for an apparatus to register a user's fingerprint features, consistent with the disclosed embodiments.

FIG. 13 illustrates a flowchart of an exemplary method for an apparatus to compare the input fingerprint features, with the registered fingerprint features consistent with the disclosed embodiments.

FIG. 14 illustrates a flowchart of an exemplary method for an apparatus to either wake up a portable device or put the device back to sleep or standby mode, depending on a fingerprint match consistent with the disclosed embodiments.

FIG. 15 illustrates a flowchart of an exemplary method for an apparatus to authenticate transactions made through Near Field Communication (NFC) devices based on fingerprint features, consistent with the disclosed embodiments.

FIG. 16 illustrates a flowchart of an exemplary method for an apparatus to register a user's fingerprint features for an exemplary fast dialing application, consistent with the disclosed embodiments.

FIG. 17 illustrates a flowchart of an exemplary method for an apparatus to implement an exemplary fingerprint-based fast dialing application, consistent with the disclosed embodiments.

FIG. 18 illustrates a flowchart of an exemplary method for an apparatus to execute different commands corresponding to different swiping directions, consistent with the disclosed embodiments.

FIG. 19 illustrates a flowchart of an exemplary method of an apparatus to register a user's fingerprint features for an exemplary online shopping application, consistent with the disclosed embodiments.

FIG. 20 illustrates a flowchart of an exemplary method for an apparatus to implement an exemplary fingerprint-based online shopping process, consistent with the disclosed embodiments.

FIG. 21 illustrates exemplary screen captures of the online access interface for using an exemplary fingerprint in lieu of user ID and/or password, consistent with the disclosed embodiments.

FIG. 22 illustrates another exemplary screen capture of traditional login interface, which may be easily converted or configured to accept fingerprint as an alternative to user ID and/or password, consistent with the disclosed embodiments.

FIG. 23 illustrates an exemplary embodiment of a fingerprint based remote control of a garage door system, consistent with the disclosed embodiments.

### DESCRIPTION OF THE EMBODIMENTS

Reference will now be made in detail to exemplary embodiments, examples of which are illustrated in the accompanying drawings. The following description refers to the accompanying drawings, and the same numbers in different drawings represent the same or similar elements unless otherwise represented.

The disclosed exemplary embodiments may provide one or more control mechanisms for fingerprint verification by using a fingerprint sensing device, such as a swipe sensor, to scan and/or receive fingerprint inputs in various directions, such as upward or downward scanning directions, left or right scanning directions, and other possible scanning directions. For example, a user may control an electronic or portable device, execute various commands associated with the device, or control other devices through such user device, by scanning a fingerprint in different directions. Without limiting the present disclosure, examples of such device may include a smart phone, a cellular phone, a PDA, a tablet PC, an electronic book reader, a laptop computer, an ultrabook, a netbook, a personal computer, a computing system, a music player, an electronic device, etc. In one exemplary embodiment, scanning fingers upward and downward on a swipe sensor may result in the generation of different responses, and/or execution of different commands or operations.

A fingerprint scanning method, such as one using a swipe sensor, may provide two or more sets of scanned fingerprint data or output data when the same finger is swiped in different directions. In an example having a sensor placed along a horizontal- or X-axis, upward and downward scanning may respectively result two sets of fingerprint data representing an upward-scanned fingerprint and a downward-scanned fingerprint. The two sets of fingerprint data may then be used to execute different commands.

To secure the transmission of the acquired fingerprint data in some embodiments, some level of security may be provided to prevent potential interception or security breach. To provide or add the security of fingerprint data transmission, some of the disclosed embodiments may include certain coding algorithms, such as a Y&C (Yen & Chuang) Hybrid Encryption Method, to secure the transmission of the fingerprint data. The disclosed embodiments may enhance the efficiency in certain or in all applications. The coding algorithms, such as a Y&C (Yen & Chuang) Hybrid Encryption Method, may be implemented on an apparatus to prevent the fingerprint data from being stolen, hacked, intercepted, or fraudulently used by others. The encryption method may be a hybrid one. A fixed code may be stored in both a portable device and a remote processing device. The fixed code may be used along with a temporary or real-time code generated from the remote process device.

Some of the exemplary embodiments may provide or utilize apparatuses, such as portable devices including a smart phone, a cellular phone, a tablet PC, an electronic book reader, a laptop computer, a netbook, a personal computer, a PDA, a tablet PC, an ultrabook, a music player or any other handheld device, a host computer, a workstation, a server or server blade, and any other processor or local, client, or remote processing devices. Exemplary embodiments may also provide methods for operating a system or a device based on fingerprint scanning inputs. In one example, the portable device may receive a fingerprint input by a fingerprint sensor, generate fingerprint feature data, compare the fingerprint data to that stored in a database and execute different commands based on different fingerprint scanning directions. In another example, the portable device may transmit the fingerprint data, encoded or un-encoded, to a remote processing device, wherein the remote processing device may decode the encrypted fingerprint feature data if the data are encoded, compare the fingerprint data to the data or a part of the data stored in a database, and execute different commands based on the results of the comparison, such as results reflecting different fingerprint swiping directions.

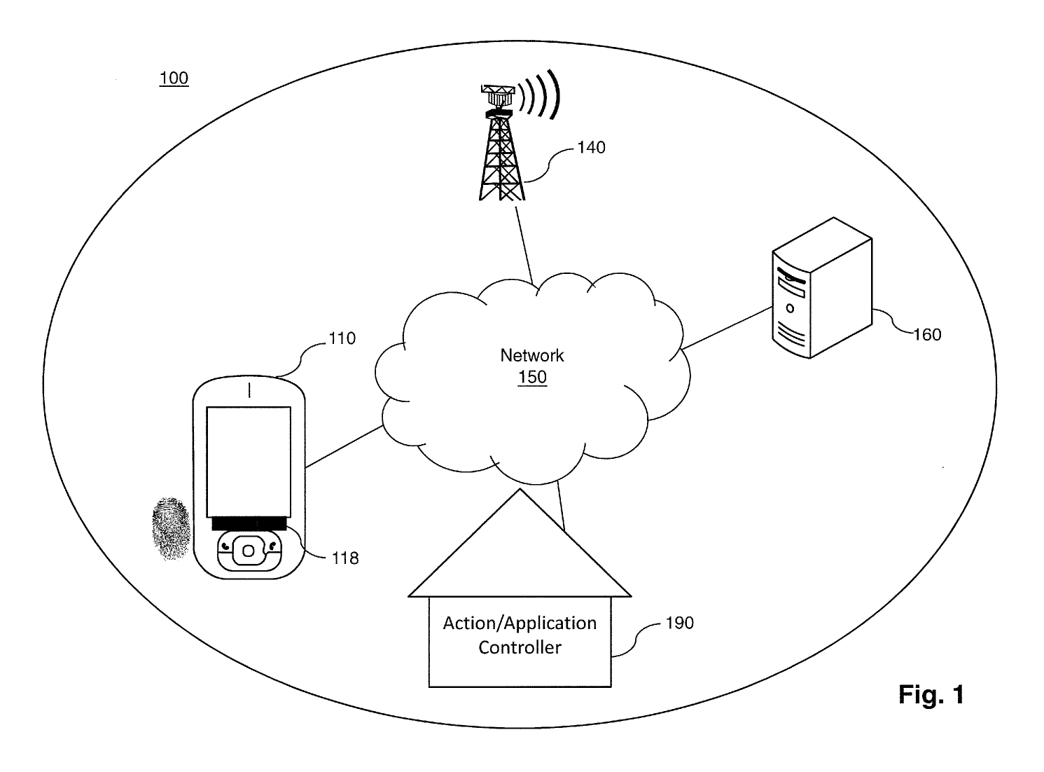

FIG. 1 illustrates a communication and control system 100 that may implement exemplary fingerprint-scanning-input-based operations consistent with the disclosed embodiments. As an example, communication and control system 100 may include Portable Device 110, Base Station 140, Network 150, Remote Processing Device 160 and Action/Application Controller 190.

Referring to FIG. 1, in exemplary embodiments, portable device 110, such as a smart phone, a cellular phone, a tablet PC, an electronic book reader, a music player, a laptop computer, a netbook, and any other handheld device, may include Fingerprint Sensor/Reader 118 configured to recognize user's fingerprint input. Fingerprint Sensor/Reader 118 may be of any kind of sensors or reader that may recognize a biometric fingerprint, including capacitive sensors such as the one shown in FIG. 1, optical, ultrasonic sensors or any other fingerprint sensors. Although Fingerprint Sensor/Reader 118 in FIG. 1 is shown as integrated within portable device 110, it is understood by those skilled in the art that portable device 110 may be configured to work with any integrated or external fingerprint sensors or readers, which may be connected to portable device 110 through wired or wireless communication links such as USB, mini-USB, 802.11, Wi-Fi, or any other suitable communication links. Exemplary fingerprint sensors or reader include Atrua® or AuthenTec® fingerprint sensors, Eikon®, HP®, Microsoft®, and Lathem® fingerprint reader, etc. Furthermore, when sensor/reader 118 is integrated with portable device 110, it may be placed in any part of portable device 110 and in any orientation such as horizontal (as shown in FIG. 1), vertical or any other desired orientation.

Referring still to FIG. 1, in exemplary embodiments, Action/Application Controller 190 may be any hardware devices or software applications that are capable of executing a command based on user identify authentication. Exemplary controller devices include garage door controllers, mobile phone dialing controllers, Near Field Communication (NFC) based transaction controllers, door lock/unlock devices, strongbox/safe access controllers, etc. In some exemplary embodiments, Action/Application Controller 190 may also be software applications such as online shopping, login bank accounts, online stock exchange, or any other online or offline transactions that may require authentication of the user's identity.

Referring still to FIG. 1, in exemplary embodiments, the Base Station 140 may be configured to communicate with portable device 110 and Remote Processing Device 160 through Network 150. Remote Processing Device 160 may be configured to communicate with Action/Application Controller 190. In some exemplary embodiments, portable device 110 may also be configured to communicate directly with Remote Processing Device 160 through Network 150 without intervention from Base Station 140. In some exemplary embodiments, portable device 110 may also be configured to communicate directly with Action/Application Controller 190 without intervention from both Base Station 140 and Remote Processing Device 160. In some exemplary embodiments, Network 150 may be wired or wireless and may be internet or intranet or any other form of networking.

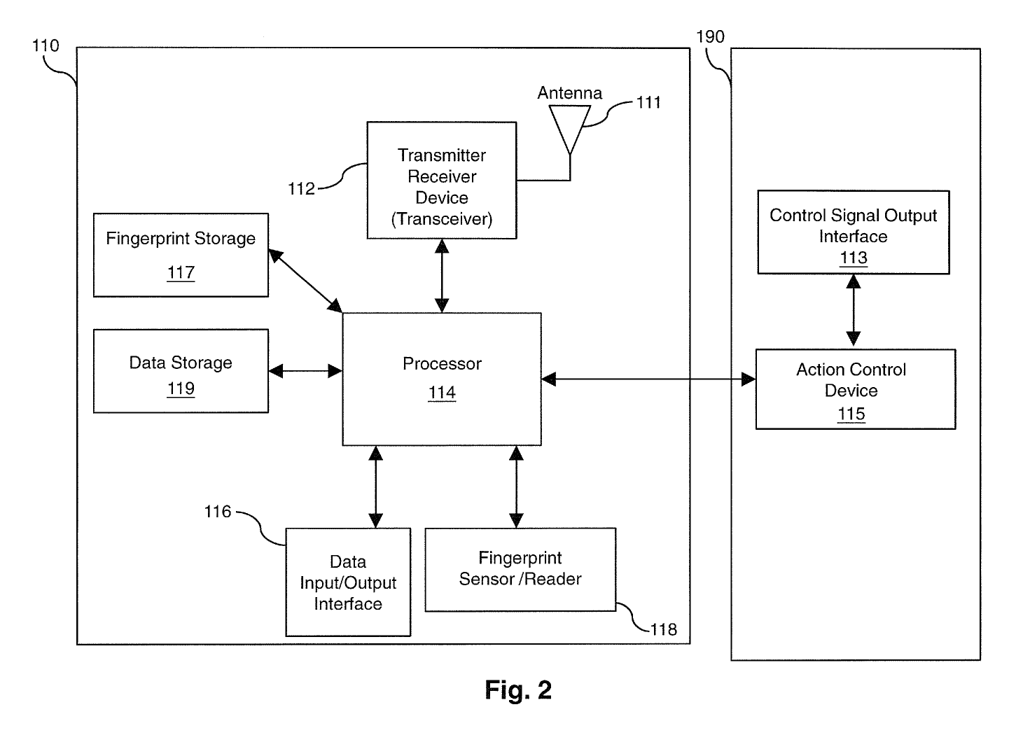

FIG. 2 illustrates a block diagram of portable device 110 and Action/Application Controller 190 consistent with the disclosed embodiments. In some exemplary embodiments, portable device 110 may include Antenna 111, Transmitter/Receiver Device 112, Processor 114, Data Input/Output Interface 116, Fingerprint Storage 117, Fingerprint Sensor/Reader 118, and Data Storage 119. Action/Application Controller 190 may include Action Control Device 115 and Control Signal Output Interface 113.

Referring to FIG. 2, in some exemplary embodiments, Processor 114 may be connected or coupled to Fingerprint Sensor/Reader 118. Processor 114 may be of any general or specific purpose processors that are capable of performing data communication, controlling and execution functions. For example, the processor may be a STMicroelectronics STM32F105 microprocessor. In some exemplary embodiments, Fingerprint Sensor/Reader 118 recognizes the input of fingerprints, captures the fingerprints and communicates the fingerprints to Processor 114. Fingerprint Sensor/Reader 118 may be coupled or connected to Processor 114 through any compatible input/output interfaces such as GPIO (General Purpose Input/Output), SPI (Serial Peripheral Interface), I²C(Inter-Integrated Circuit), USB(Universal Serial Bus), mini-USB, PCI(Peripheral Component Interconnect), PCI-Express, etc. After Processor 114 receives the fingerprints, it may generate fingerprint features data representing features of the fingerprint input.

Referring still to FIG. 2, in some exemplary embodiments, Processor 114 may also be connected or coupled to wireless Transmitter/Receiver Device (Transceiver) 112 associated with Antenna 111. In some exemplary embodiments, transceiver 112 may be configured to transmit the fingerprint feature data to Remote Processing Device 160 in FIG. 1 for further operations. In some exemplary embodiments, transceiver 112 may also be configured to receive fingerprint feature data from other portable devices or remote processor devices. In some exemplary embodiments, the transmitted or received fingerprint data may also be encrypted. Transceiver 112 may be of any type of wireless transceiver that is capable of processing radio signals, for example, a NORDC nRF905 transceiver chip. In some embodiments, the transceiver's transmitting frequency may be 433 MHz, 868 MHz, and 915 MHz (three bands), and/or any other suitable transmitting frequencies. The transceiver may employ any analog or digital modulation scheme such as ASK (Amplitude Shift Keying), PSK (Phase Shift Keying), and FSK (Frequency Shift Keying). For example, the nRF905 chip employs a GFSK (Gaussian frequency-shift keying) modulation scheme. In an exemplary embodiment, nRF905 may be connected or coupled to a microprocessor through SPI (serial peripheral interface) or any suitable interfaces, and the supply voltage may be 3 volts or any other suitable operating voltages.

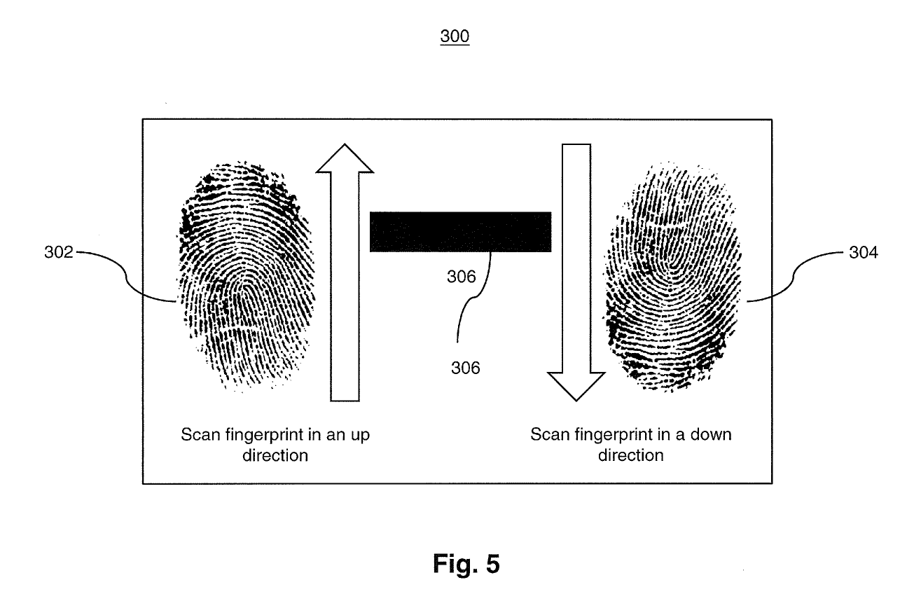

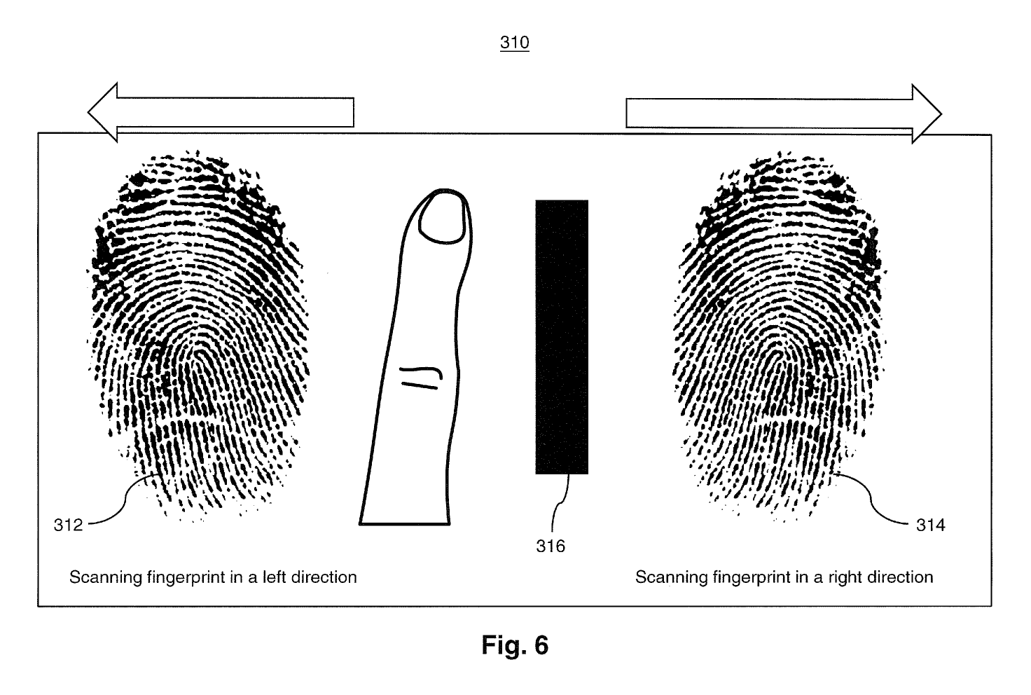

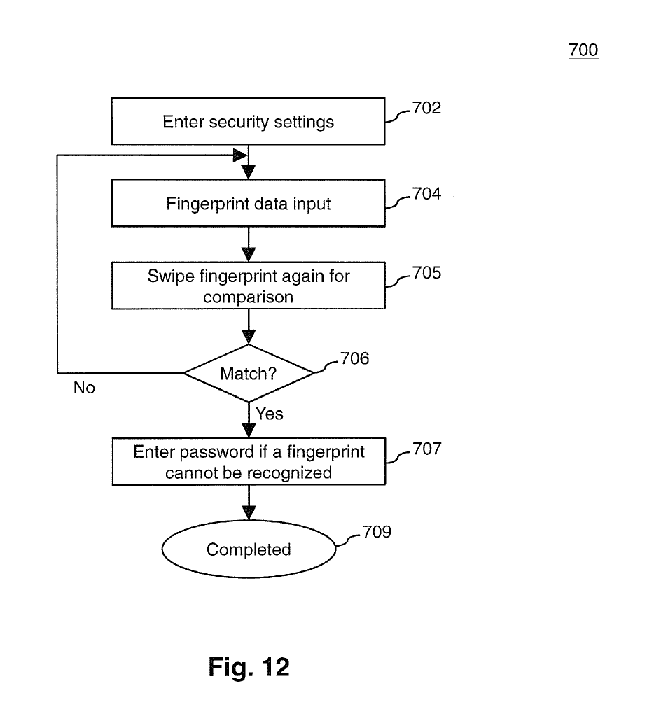

Referring still to FIG. 2, in some exemplary embodiments, after Processor 114 generates the fingerprint feature data, which may be based on fingerprints received either from Fingerprint Sensor/Reader 118 or from transceiver 112, Processor 114 may be further configured to compare the fingerprint feature data to at least a portion of a stored fingerprint data in Fingerprint Storage 117. The exemplary method of generating the stored fingerprint data will be discussed in detail below in the descriptions of FIGS. 5 and 6. The exemplary method of registration of the stored fingerprint data will be discussed in detail below in the description of FIG. 12. In some exemplary embodiments, if the fingerprint features data being compared results in a first match reflecting that the fingerprint input occurred in a first direction, Processor 114 may be configured to execute a first command. If the fingerprint features data being compared results in a second match reflecting that the fingerprint input that occurred in a second direction, Processor 114 may be configured to execute a second command. If no-match results, Processor 114 may be configured to execute a third command. It is understood by one skilled in the art that Processor 114 is not limited to execute three commands corresponding to three described fingerprint directions. Processor 114 may be configured to execute any number of commands in response to fingerprint inputs occurring in any number of directions. The direction may be substantially horizontal, substantially vertical, or any other direction.

Referring still to FIG. 2, in some exemplary embodiments, Processor 114 may be further connected or coupled to Action/Application Controller 190. Processor 114 may be configured to send the commands in response to different fingerprint input directions, to Action Control Device 115 of Action/Application Controller 190. The Action Control Device 115 may generate control signals corresponding to the commands received and send the control signals through an output interface to cause certain actions to be performed. For example, in a vehicle-related application, Processor 114 may be coupled or connected with a vehicle or a garage-door opener through a communication link such as Wi-Fi, WiMax, Bluetooth, NFC links, infrared or any other wireless links, to provide vehicle-control or garage-door-control command signal(s). In one exemplary embodiment, if Processor 114 detects an upward swiping of the fingerprint from an authorized user, it generates and sends a command to a garage door opener device, which then generates a control signal to open the garage door. Similarly, if Processor 114 detects a downward swiping of the fingerprint, it sends the command to the door opener to close the garage door.

Referring still to FIG. 2, it is understood by those skilled in the art that Action/Application Controller 190 is not limited to a garage-door opener as described above. Any type of controller 190 may be configured to connect or couple with portable device 110 for performing desired control functions via the directional finger-swiping method. Such controller functions may include door lock/unlock, strongbox lock/unlock, community gate opener, vehicle access control, parent control in consumer electronics such TV, computers, etc. The communication links and interfaces between processor 110 and remote processing device 190 may be a wired communication link such as GPIO, SPI, I²C, USB, min-USB, PCI, PCIexpress, etc., or may be wireless communication links.

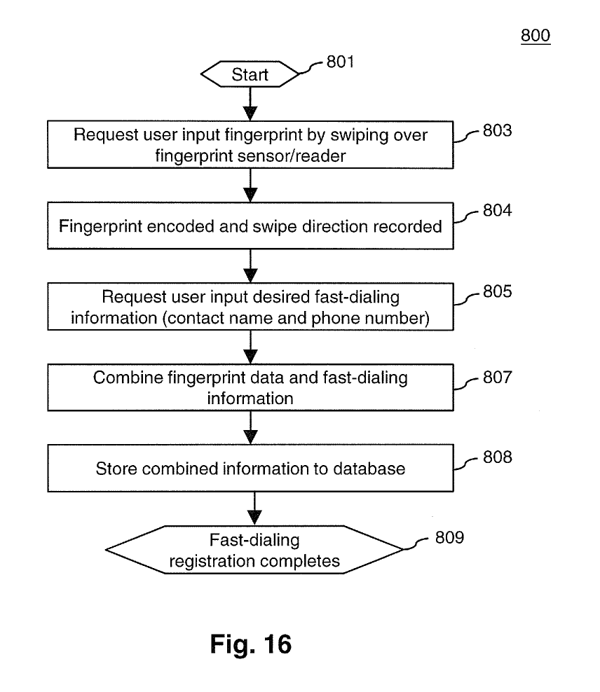

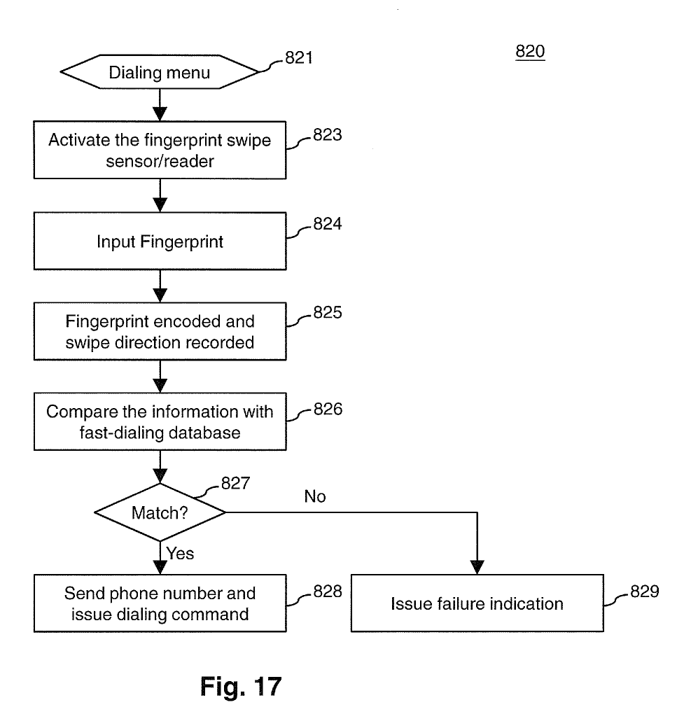

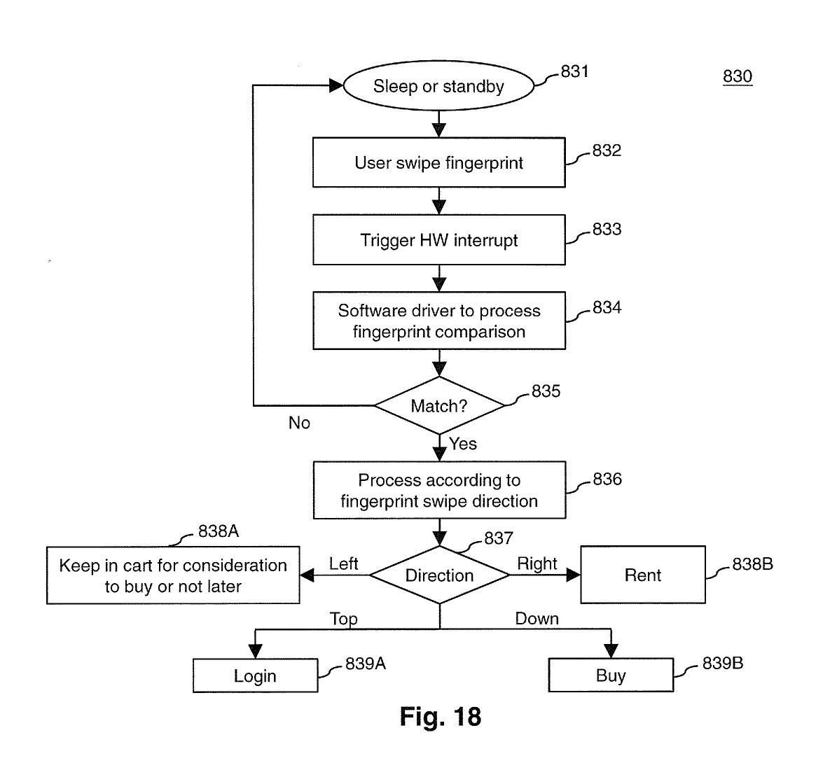

Referring still to FIG. 2, in some exemplary embodiments, Action/Application Controller 190 may not be required. For example, in applications such as fast-dialing or online shopping, the application may be implemented directly on portable device 110. Different commands generated by Processor 114 corresponding to different fingerprint swiping directions may be communicated internally within portable device 110 to trigger predetermined actions. The fast-dialing application will be described in detail in FIGS. 16-17 and the online shopping application will be described in detail in FIGS. 18-20.

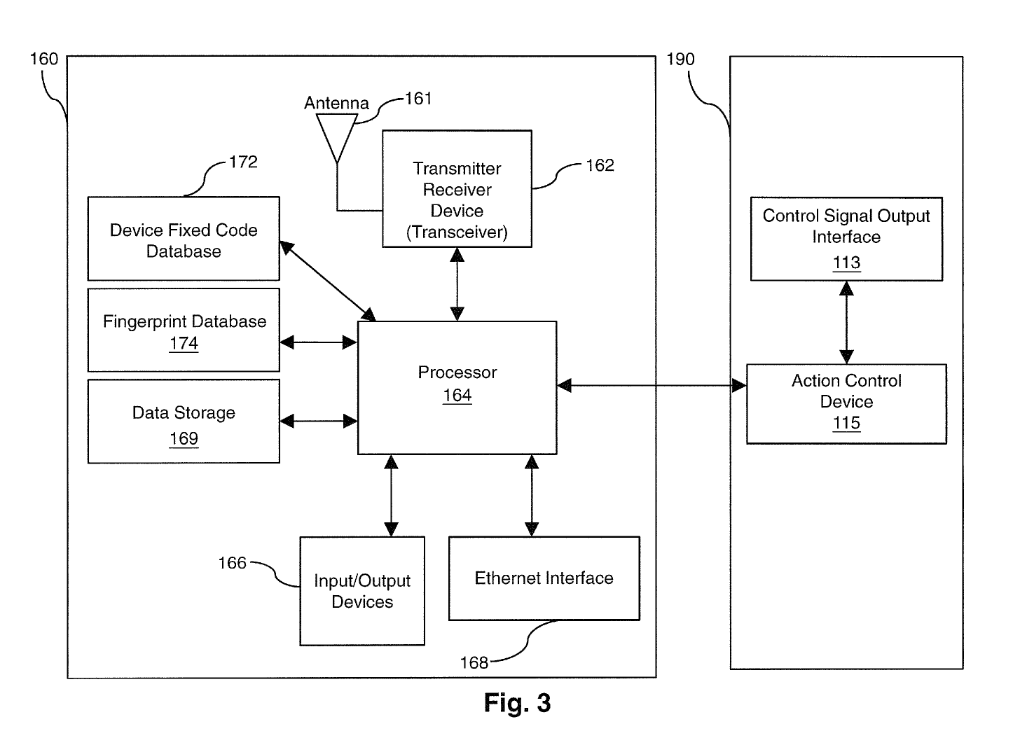

FIG. 3 illustrates a block diagram of Remote Processing Device 160 consistent with the disclosed embodiments. In some exemplary embodiments, portable device 110 in FIG. 1 may simply transmit the fingerprint feature data to Remote Processing Device 160 for further operations. Remote Processing Device 160 may include Antenna 161, Transmitter Receiver Device 162, Processor 164, Input/Output Interface 166, Ethernet Interface 168, Data Storage 169, and Fingerprint Database 174. In some exemplary embodiments, Remote Processing Device 160 may also include an optional Device Fixed Code Database 172 for storing fixed codes of all registered devices such as Portable Device 110. Action/Application Controller 190 may be the same as the one described above in FIG. 2 and may include Action Control Device 115 and Control Signal Output Interface 113.

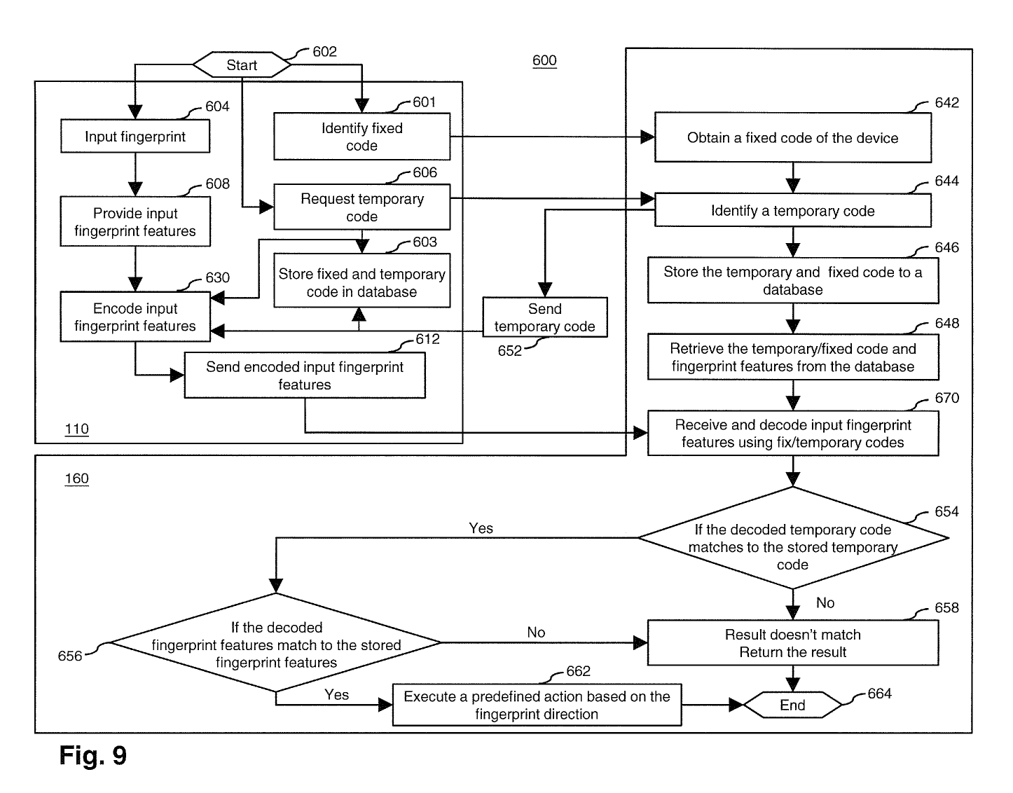

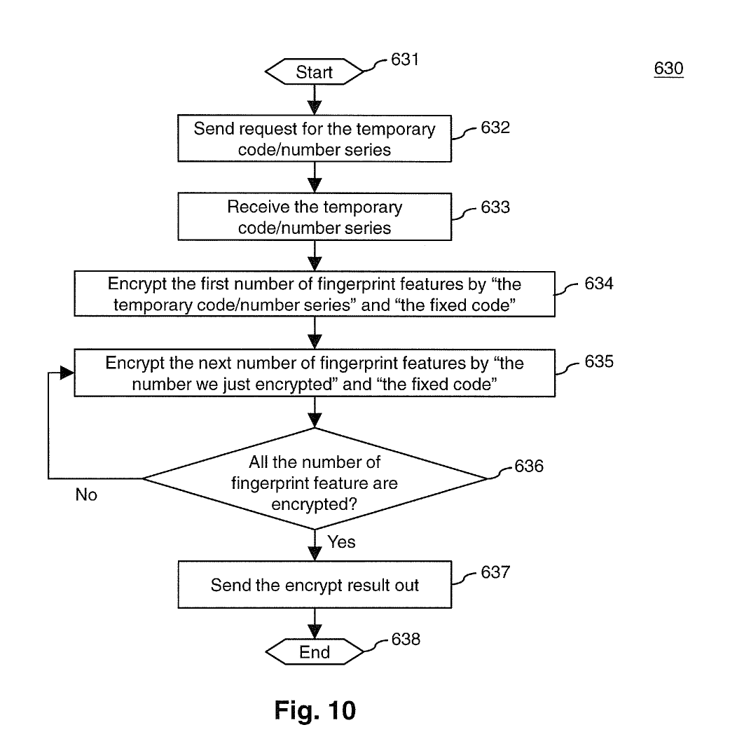

Referring to FIG. 3, in some exemplary embodiments, Processor 164 may be connected or coupled to Transmitter Receiver Device 162 associated with Antenna 161. In some exemplary embodiments, Transceiver Receiver Device 162 may be configured to receive fingerprint feature data from a portable device. In some exemplary embodiments, the received fingerprint data may be encrypted. A detailed description of the encryption method will be discussed in the description of FIGS. 9-10 below. Transceiver Receiver Device 162 may be any type of wireless transceiver that is capable of processing radio signals, for example, a NORDC nRF905 transceiver chip.

Referring still to FIG. 3, in some exemplary embodiments, after Processor 164 receives the fingerprint features data, Processor 164 may be configured to compare the fingerprint features data to at least a portion of a stored fingerprint data in Fingerprint Database 174. The exemplary method of generating the stored fingerprint data will be discussed in detail below in the description of FIGS. 5 and 6. The exemplary method of registration of the stored fingerprint data will be discussed in detail below in the description of FIG. 12. In some exemplary embodiments, if the fingerprint feature data being compared results in a first match reflecting that the fingerprint input occurred in a first direction, Processor 164 may be configured to execute a first command. If the fingerprint feature data being compared results in a second match reflecting that the fingerprint input occurred in a second direction, Processor 164 may be configured to execute a second command. If no-match results, Processor 164 may be configured to execute a third command. It is understood by one skilled in the art that Processor 164 is not limited to execute three commands corresponding to three fingerprint directions. Processor 164 may be configured to execute any number of commands in response to any number of fingerprint input directions.

Referring still to FIG. 3, in some exemplary embodiments, Processor 164 may be further connected or coupled to Action/Application Controller 190. Processor 164 may be configured to send the commands in response to different fingerprint inputs directions, to Action Control Device 115 of Action/Application Controller 190. Action Control Device 115 may generate control signals corresponding to the commands received and transmit the control signals through an output interface (113) to cause certain actions to be performed. For example, in a vehicle-related application, Processor 164 may be coupled with a vehicle or a garage-door opener through a wired communication link or data bus or interface, such as through a CAN (Controller Area Network) bus connector via a CAN transceiver chip, such as TI®'s SN65HVD230DDK, to provide vehicle-control or garage-door-control signal(s). In some exemplary embodiments, once Processor 164 detects an upward swiping of the fingerprint from an authorized user, it sends a command to a garage door opener device, which then sends out a control signal in order to open the garage door. In some exemplary embodiments, Processor 164 may also be coupled to other type of controllers through communication links and interfaces such as GPIO header, SP¹, I²C, USB, min-USB, PCI, PClexpress, and Ethernet connections, etc. In some exemplary embodiments, processor 164 may also be coupled to Action/Application Controller 190 though wireless communication link such as Wi-Fi, WiMax, Bluetooth, NFC links, Infrared or any other wireless links. The coupling of the processor to an Ethernet or other internet connections may allow fingerprint-swiping based network authentication to be implemented.

Referring still to FIG. 3, it is understood by those skilled in the art that controller 190 is not limited to a garage-door opener described above. Any type of controller 190 may be configured to connect or couple with Portable Device 160 for performing desired control functions via the directional finger-swiping method. Such controller functions may include door lock/unlock, strongbox lock/unlock, community gate opener, vehicle access control, parent control in consumer electronics such TV, computers, etc. The communication links and interfaces between processor 164 and the remote processing device 190 may be a wired communication link such as GPIO, SP¹, I²C, USB, min-USB, PCI, PCIexpress, etc., or may be wireless communication links.

Referring still to FIG. 3, in some exemplary embodiments, external action controller 190 may not be required. For example, in applications such as fast-dialing or online shopping, the application may be implemented directly on Remote Processing Device 160 in FIG. 3 or Portable Device 110 in FIG. 2 Different commands generated by Processor 164 corresponding to different fingerprint swiping directions may be communicated internally within Remote Processing Device 160 to trigger predetermined actions. The fast-dialing application will be described in detail in FIGS. 16-17 and the online shopping application will be described in detail in FIGS. 18-20.

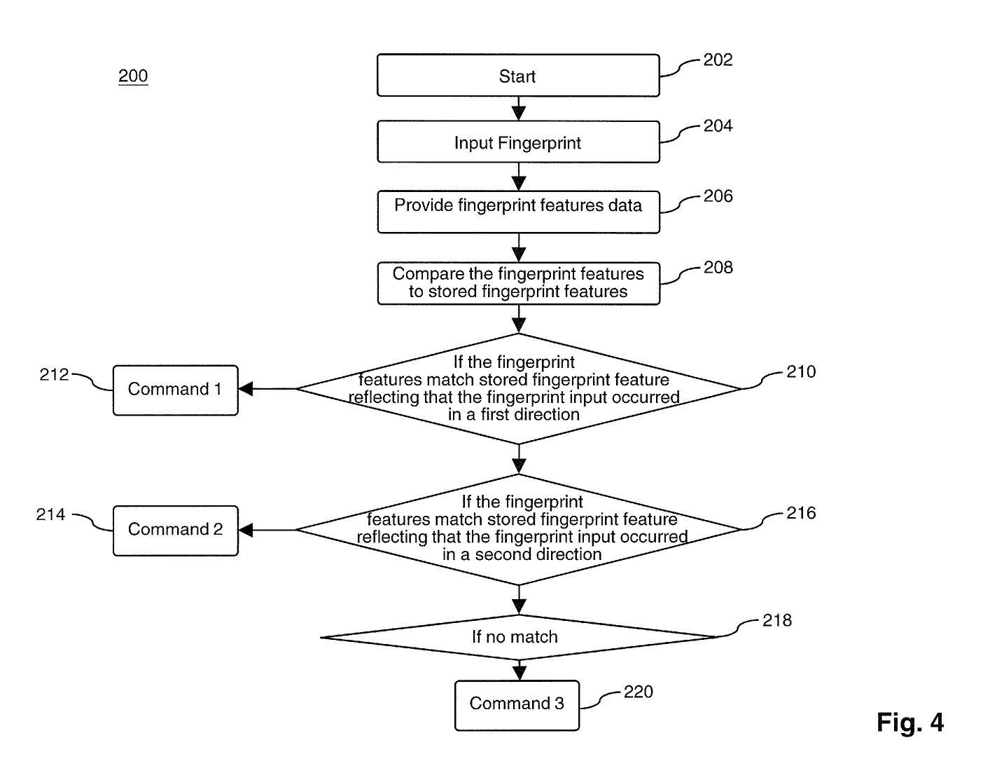

FIG. 4 illustrates a flowchart of an exemplary method 200 for an apparatus to execute commands based on fingerprint input direction consistent with the disclosed embodiments. In some exemplary embodiments, the apparatus may be Portable Device 110 in FIG. 1 or Remote Processing Device 160 in FIG. 1 or both. In step 204, the apparatus may receive a fingerprint input from a user's finger swiping over a fingerprint sensor or reader; or the apparatus may receive a fingerprint through a transceiver. Processor 114 or 164 of the apparatus may generate the fingerprint features data representing features of the fingerprint input (206). Processor 114 or 164 of the apparatus may then compare the fingerprint feature data to at least a portion of a stored fingerprint data (208). If the fingerprint feature data being compared results in a first match reflecting that the fingerprint input occurred in a first direction (210), Processor 114 or 164 may execute a first command (212). If the fingerprint feature data being compared results in a second match reflecting that the fingerprint input occurred in a second direction (216), Processor 114 or 164 may execute a second command (214). If the fingerprint feature data being compared results in a non-match (218), Processor 114 or 164 may execute a third command (220). The first and second directions may be any substantially directions including up, down, left, right or any other directions. It is also understood by those skilled in the art that the number of matches and commands are not limited to 3. Depending on particular applications, the number of matches and commands can be of any number corresponding to any number of finger swiping directions desired.

Referring to FIG. 4, in some exemplary embodiments, the stored fingerprint data may comprise stored fingerprint feature data reflecting a first set of features corresponding to a first finger scanning direction (210) and a second set of features corresponding to a second finger scanning direction (216). The first match may correspond to a feature match of the fingerprint feature data with the first set of features (210), and the second match may correspond to a feature match of the fingerprint feature data with the second set of features (216). The first direction may be substantially opposite to the second direction, and the first direction may be one of a substantially horizontal direction and a substantially vertical direction.

FIG. 5 illustrates an exemplary fingerprint swiping over an exemplary Fingerprint Sensor/Reader 306 in substantially vertical directions consistent with the disclosed embodiments (300). In some exemplary embodiments, fingerprint data representing two fingerprint patterns may be captured when the same finger is scanned in opposite directions. For example, during a fingerprint registration process, a user may be required to swipe his/her finger in both upward and downward directions and the fingerprint patterns received by the sensor are both captured and stored. In other embodiments, the fingerprint pattern received or collected by scanning the finger over a Fingerprint Sensor/Reader 306 in a downward direction (304) may be mirrored vertically to generate a fingerprint pattern same or substantially same as pattern received by scanning the finger in the upward direction (302).

Referring still to FIGS. 4 and 5, in some embodiments, a user may wish to trigger command 2 (214), which is a predetermined command corresponding to swiping a finger in a downward direction. If the user swipes his/her finger in a downward direction, the Fingerprint Sensor/Reader 306 captures the fingerprint and generates a fingerprint pattern (304). If this fingerprint pattern is first compared, by Processor 114 or 164, to fingerprint patterns reflecting that the fingerprint input occurred in an upward direction, the match may fail. Processor 114 or 164 may then proceed to compare the captured downward-scanned fingerprint pattern (304) to a stored or registered downward-scanned fingerprint pattern, which was generated either by actual scanning or mirroring during the registration process. A match may then result to trigger the desired command 2. In some exemplary embodiments, one or both of the two fingerprint patterns may be used for fingerprint verifications or authentication. The upward-scanned and downward-scanned fingerprint patterns, or fingerprint patterns generated by scanning in different or other directions, therefore, may be used to control a device's responses to a user's specific scanning directions.

Referring still to FIG. 6, Fingerprint Sensor/Reader 316 may be placed vertically instead of horizontally as Fingerprint Sensor/Reader 306 as shown in FIG. 5. Method 200 in FIG. 4 and other any other methods described in this specification may be used to identify the display mode and the corresponding fingerprint scanning direction for action. The advantage is that as long as the fingerprint scanning direction is well defined by the respective executive action, Fingerprint Sensor/Reader 306 or 316 may be placed flexibly. For example, the method 200 in FIG. 4 may be implemented to open a garage door by issuing command 1, close the door by issuing command 2, or take no action by issuing command 3. Thus, regardless of whether Fingerprint Sensor/Reader 306 or 316 is placed vertically or horizontally, garage door controller can respond correctly to different fingerprint scanning directions. Similarly, in other exemplary embodiments, as long as the fingerprint features match, a specific action may be performed based on the fingerprint input direction regardless of how the fingerprint sensor is placed. A non-matching of the fingerprint features may result in no action or another predefined specific action.

FIG. 6 illustrates an exemplary fingerprint swiping over an exemplary Fingerprint Sensor/Reader 316 in substantially horizontal directions consistent with the disclosed embodiments (310). Similar to those described in FIG. 5, in some exemplary embodiments, fingerprint data representing two fingerprint patterns may be captured when the same finger is scanned in opposite horizontal or substantially horizontal directions. For example, during a fingerprint registration process, a user may be required to swipe his/her finger in both left and right directions and the fingerprint patterns received by the sensor are both captured and stored. In other embodiments, the fingerprint pattern received or collected by scanning the finger over Fingerprint Sensor/Reader 316 in a rightward direction (314) may be mirrored horizontally to generate a fingerprint pattern same or substantially same as pattern received by scanning the finger in the leftward direction Therefore, during a fingerprint based command issuing flow such as the one showed in FIG. 4, a user's input fingerprint pattern may be compared to one or both patterns generated and stored during the registration process.

Referring to both FIGS. 5 and 6, with the embodiments disclosed herein, those skilled in the art understand that both vertical and horizontal mirroring may be used in registration and authentication/command-issuing process. Also, any other mirroring of fingerprints on substantially opposite directions may also be implemented similarly.

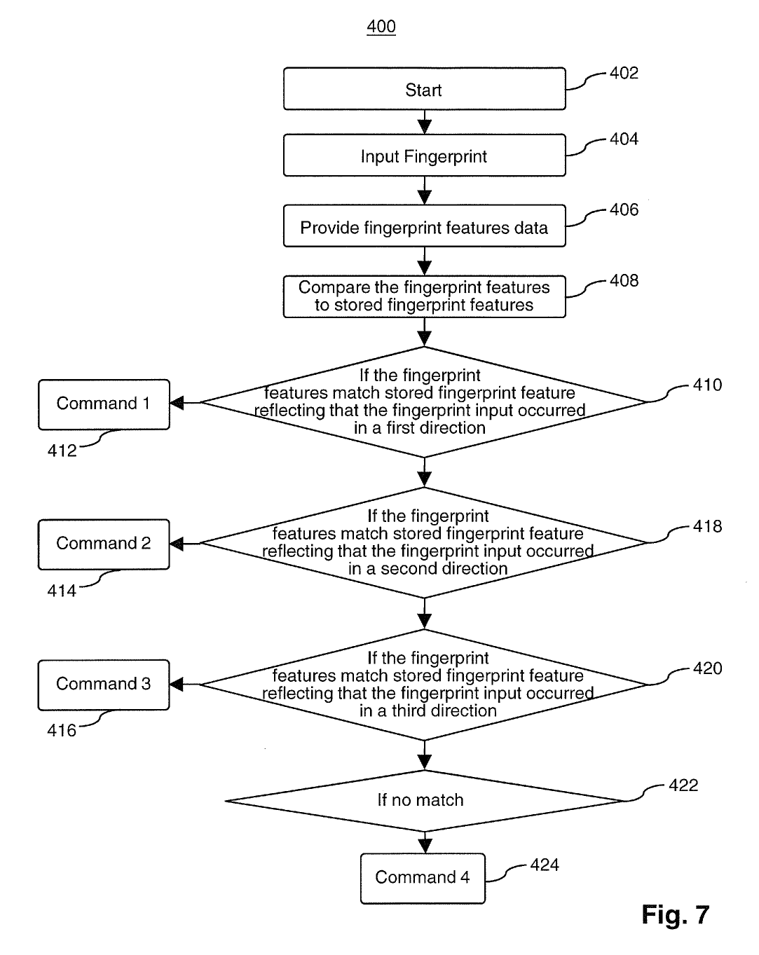

FIG. 7 illustrates a flowchart of an exemplary method 400 for an apparatus to execute commands based on fingerprint input directions consistent with the disclosed embodiments. In some exemplary embodiments, the apparatus may be Portable Device 110 or Remote Processing Device 160 or both as shown in FIG. 1. The apparatus receives an input fingerprint (404). The apparatus may generate the fingerprint feature data representing features of the fingerprint input (406). The apparatus may compare the fingerprint feature data to at least a portion of a stored fingerprint data (408). If the fingerprint feature data being compared results in a first match reflecting that the fingerprint input occurred in a first direction (410), the apparatus may execute a first command (412). If the fingerprint feature data being compared results in a second match reflecting that the fingerprint input occurred in a second direction (418), the apparatus may execute a second command (414). If the fingerprint feature data being compared results in a third match reflecting that the fingerprint input occurred in a third direction (420), the apparatus may execute a third command (416). If the fingerprint feature data being compared results in a non-match (422), the apparatus may execute a fourth command (424). The first, second, and third directions may be any, one of up, down, left or right as described above. It is also understood by those skilled in the art that the number of matches and commands are not limited to 4. Depending on the implementation, the number of matches and commands can be of any number corresponding to number of finger swiping directions desired.

Referring to FIGS. 4 and 7, fingerprint input directions and corresponding actions may be defined or configured in advance or modified or updated over time. A user may define the fingerprint scanning direction that calls for the execution of a corresponding action or actions. A user may also pre-register and/or store the fingerprint(s) that need to be recognized. In some exemplary embodiments, fingerprint inputs through a fingerprint sensor may cause a device to identify the fingerprint features and the scan directions, which would lead to a specific action, actions, or non-action. Users, therefore, may use the “fingerprint” as a security measure and use one of the “scanning directions” that combines one or more commands that triggers user operations, such as pointing to specific icons on a touch screen to cause the desired action(s).

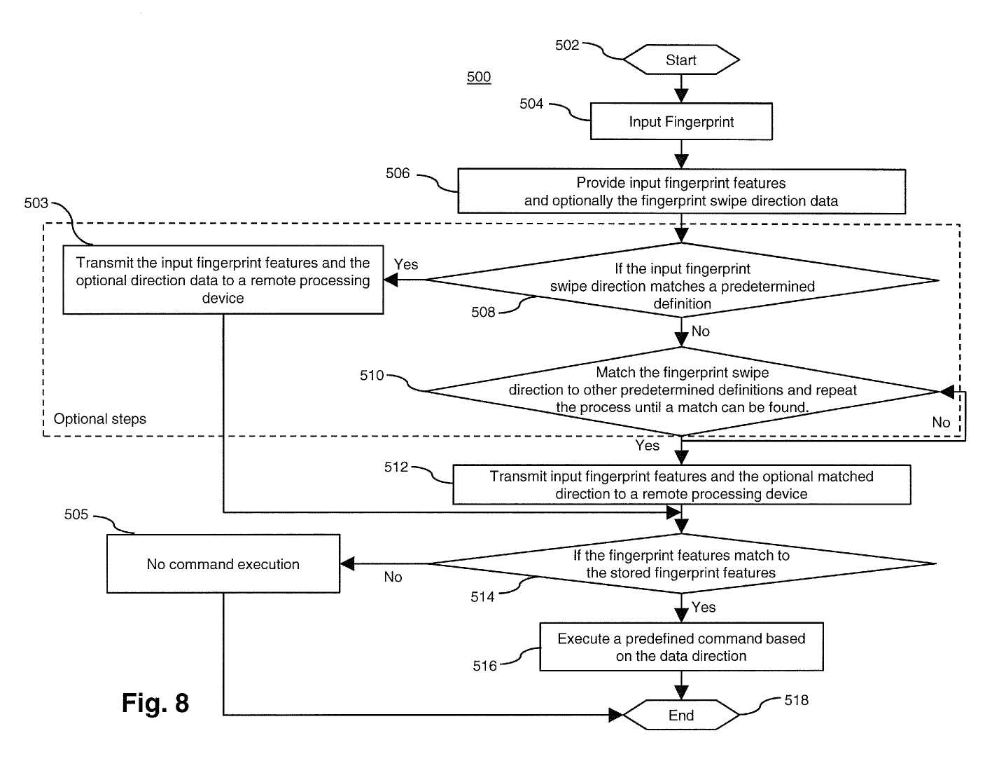

FIG. 8 illustrates a flowchart of an exemplary method 500 for Portable Device 110 to transmit fingerprint feature data to Remote Processing Device 160 consistent with the disclosed embodiments. In some exemplary embodiments, Portable Device 110 may use a Network 150 for conducting fingerprint verification or authentication. In these embodiments, one or more remote processing devices 160 such as a host or server computer may be involved. Under such network environment conditions, it may be desired to have Remote Processing Device 160 compare fingerprint features, and inform the client device about the comparison results. Alternatively, Remote Processing Device 160 may execute commands itself accordingly to the input fingerprint directions.

Referring to FIG. 8, in some exemplary embodiments of exemplary method 500, the users' fingerprints were captured (504); Portable Device 110 provides the fingerprint feature data representing features of the fingerprint input (506); the fingerprint features are transmitted from Portable Device 110 to Remote Processing Device 160 (512). Remote Processing Device 160 compares the received fingerprint features to the stored fingerprint features (514) and executes a predefined command based on the data direction, if a match is found (516). If no match is found, Remote Processing Device 160 executes no command (505). Alternatively, Remote Processing Device 160 may simply match the fingerprint features (514) and transmit the fingerprint matching results back to Portable Device 110 (not shown in FIG. 8). In this case, the command execution steps (516 and 505) may be implemented on Portable Device 110 similar to those in the flow shown in FIG. 4.

Referring still to FIG. 8, in some other embodiments, method 500 may also include optional steps 508, 503, and 510. At step 506, Portable Device 110 may provide both the fingerprint feature data representing features of the fingerprint input and the fingerprint swiping direction data. At step 508, Portable Device 110 compares the swipe direction to a predetermined definition. If a match is found, Portable Device 110 transmits the input fingerprint features and the direction data to Remote Processing Device 160 (512). Remote Processing Device 160 processes the data from step 514 and beyond in the same way described above. If at step 508, no match is found, Portable Device 110 attempts to match the direction to other predetermined definitions and repeats the process until a match can be found (510). After the match is found, Portable Device 110 proceeds to step 512 to transmit input fingerprint features and the matched direction to a remote processing device.

FIG. 9 illustrates a flowchart of an exemplary method 600 for Portable Device 110 to transmit encoded fingerprint feature data to Remote Processing Device 160, for executing commands by the remote processing device based on the received fingerprint features, consistent with the disclosed embodiments. In some exemplary embodiments, Portable Device 110 may encrypt or encode the fingerprint features before transmitting the fingerprint features to Remote Processing Device 160. Correspondingly, Remote Processing Device 160 may need to decrypt or decode the fingerprint features received. Method 600 may be used to ensure the security of the transmitted data during the user authentication process. Method 600 is described in detail below.

Referring to FIG. 9, in some exemplary embodiments, Portable Device 110 may identify a fix code associated with the device (601); request a temporary code (606) from Remote Processing Device 160 or alternatively generate a temporary code on its own; receive a fingerprint input (604); provide input fingerprint features (608); encode the fingerprint features (630) based on at least one of the fixed code and the temporary code; store the fixed code and temporary code in a database (603) and send the encoded fingerprint features to Remote Processing Device 160 (612). In some exemplary embodiments, the temporary code may be encoded along with the fingerprint features during step 630.

Referring still to FIG. 9, in some exemplary embodiments, Remote Processing Device 160 may obtain a fixed code of the device from a database (642); identify a temporary code (644) from one of Portable Device 110 and a processor of Remote Processing Device 160 send the temporary code to the client device (652); store the fixed code and the temporary code in a database (646); receive the encrypted fingerprint feature data encoded based on at least one of the fixed code and the temporary code from the client device (670); retrieve the fixed code and the temporary code from the database (648); and decode the encrypted fingerprint data (670). If the encryption by the Portable Device 110 is based on both the fixed code and the temporary code (630), Remote Processing Device 160 may first decode the temporary code and compare the decoded temporary code with the stored temporary code to verify whether they match (654). A successful match may indicate that the client device is an authorized device. Remote Processing Device 160 then compares whether the decoded fingerprint features match to the stored fingerprint features (656) and executes a predefined action based on the fingerprint swiping direction (662). If the decoding is unsuccessful, no further action may be taken (658). Step 654 may be optional if the encoding by the Portable Device 110 does not include a temporary code. It is understood that after the successful decoding, the comparison of the fingerprints and execution thereafter may be performed in same or similar steps such as steps 210-220 as described in method 200 or steps 410-424 as described in method 400.

FIG. 10 illustrates a flowchart of an exemplary method 630 for Portable Device 110 to encrypt the fingerprint feature data consistent with the disclosed embodiments. In some exemplary embodiments, Portable Device 110 sends request to Remote Processing Device 160 such as a server for the temporary code/number series such as a real-time code in the form of a number series (632). Portable Device 110 receives the temporary code/number series (633) and may use it together with the only number series, i.e., the fixed code of Portable Device 110 to encrypt “the first digit” (or a first group or first feature) of the fingerprint data (634). Portable Device 110 may subsequently encrypt the “the second digit” (or a second group or second feature) of the fingerprint with the previously encrypted first digit (635). The process may repeat itself until the last digit (or last group or last feature) of the fingerprint data is encrypted (636). Portable Device 110 may then send the entire encrypted fingerprint features to the remote processing device (637).

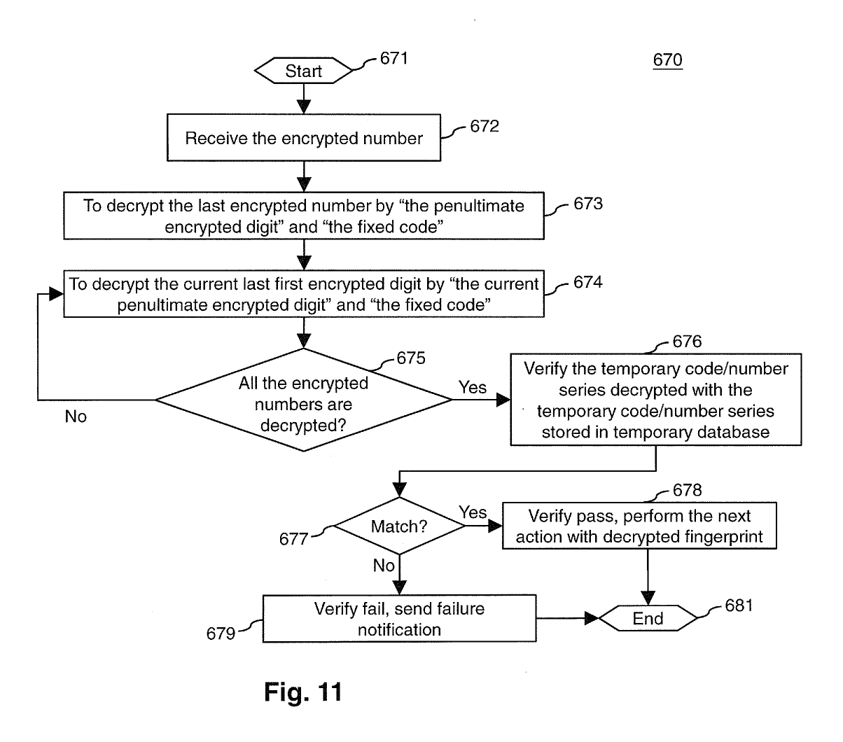

FIG. 11 illustrates a flowchart of an exemplary method 670 for Remote Processing Device 160 to decrypt the encrypted fingerprint feature data transmitted by Portable Device 110, consistent with the disclosed embodiments. In some exemplary embodiments, Remote Processing Device 160 receives the encrypted fingerprint features in the format of encrypted number series from Portable Device 110 (672). The remote processing Portable Device 110 decrypts the last digit (or last group or last feature) in the encrypted number series by using penultimate encrypted digit and the fixed code (673). After the last digit is decrypted, Remote Processing Device 160 may decrypt the second last digit (or second last group or second last feature) in the encrypted number series by using the next current penultimate encrypted digit and the fixed code (674). The decryption process may repeat until the all the encrypted numbers are decrypted and decryption is complete (675). Remote Processing Device 160 may then compare the decrypted temporary code/number series with the stored temporary code/number series in the temporary database (676). If they match (677), the verification/authentication passes (678), and Remote Processing Device 160 will decide whether or not the fingerprint is the correct one and execute instructions accordingly (678). If the numbers do not match (677), a failure notification may be sent to Portable Device 110 (679).

Referring to FIGS. 10 and 11, details of an exemplary implementation of the encryption/decryption method, the Y&C (Yen and Chuang) hybrid methods are described below. In the Y&C hybrid methods, each Portable Device 110 may own a unique serial number, an identification number, a fixed code or some kind of identifier, which may be stored in both Portable Device 110 and Remote Processing Device 160. For example, the identification number or fixed code may be 123456, which we may call it c here. This unique identifier may be used in encrypting and decrypting a fingerprint feature. This identifier is also stored in Remote Processing Device 160. When Portable Device 110 requests authorization to access Remote Processing Device 160, Portable Device 110 sends its unique identifier to Remote Processing Device 160. Remote Processing Device 160 may generate a temporary serial number (a temporary code or a real-time code), for example, based on a current millisecond of time. For example, the temporary serial number may be 1198628984102, which we may call it m here. Remote Processing Device 160 may then store the temporary serial number in a temporary database and provides it to Portable Device 110. This temporary serial number 644 may be used by Remote Processing Device 160 to verify the fingerprint feature sent by Portable Device 110.

Portable Device 110 retrieves the user's fingerprint features, which we may call it f here. Remote Processing Device 160 sends the start code (i.e. the temporary serial number) to Portable Device 110. Portable Device 110 uses the start code to encrypt all digits of the fingerprint features in a successive manner. The encryption is carried out in the following way: assuming all the fingerprint feature values are f(1)˜f(n), and the values after encryption are e(1)˜e(n+1), the encryption/encoding takes place in the following order:

$$1. ( m + c ) mod f ( 1 ) = e ( 1 )$$

$$2. ( e ( 1 ) + c ) mod e ( 1 ) = e ( 2 )$$

$$3. ( f ( 2 ) + c ) mod e ( 2 ) = e ( 3 )$$

$$…$$

$$n . ( f ( n ) + c ) mod e ( n ) = e ( n + 1 )$$

After encryption/encoding is complete, Portable Device 110 sends the encrypted e series values to Remote Processing Device 160. Remote Processing Device 160 then decrypts the e values into m and f sequences in a reverse order:

$$1. ( e ( n + 1 ) - c + e ( n ) ) mod e ( n ) = f ( n )$$

$$2. ( e ( n ) - c + e ( n - 1 ) ) mod e ( n - 1 ) = f ( n - 1 )$$

$$3. ( e ( n - 1 ) - c + e ( n - 2 ) ) mod e ( n - 2 ) = f ( n - 2 )$$

$$…$$

$$n \text{-} 1. ( e ( 2 ) - c + e ( 1 ) ) mod e ( 1 ) = f ( 1 )$$

$$n . ( e ( 1 ) - c + e ( 1 ) ) mod f ( 1 ) = m$$

Remote Processing Device 160 may then compare the decrypted m with the temporary m that is stored on Remote Processing Device 160 If a match is found, Remote Processing Device 160 may then compare the decrypted fingerprint feature f with the stored fingerprint feature on Remote Processing Device 160. If a match is also found, the authentication process completes and a connection between Portable Device 110 and Remote Processing Device 160 can be successfully established.

Because the exemplary Y&C encryption process does not need to involve altering or substantially changing fingerprint features, the fingerprint authentication process and the matching algorithm can be directly implemented on Remote Processing Device 160 as well. In addition, in order to prevent hackers from attempting to break the encryption; the initially generated data, which is based on the temporary current millisecond m, can only be used once. If the authentication fails, the system may require re-run of the whole authentication process. Furthermore, within a certain period of time, only a certain number of authentication attempts are allowed so that Remote Processing Device 160 may not be overly burdened by hackers' repeated authentication attempts. The disclosed encryption algorithms may provide following exemplary security and performance advantages in some applications.

As an illustrative example, hackers may attack network systems by intercepting the packets that have the correct ciphertext and sending it to Remote Processing Device 160 for authentication. The disclosed Y&C encryption method may prevent such attack or other types of security breaches or interceptions. The method uses changing parameters, i.e., the current millisecond, so that different ciphertext is produced each time even with the same fingerprint features. In addition, the number of attempts to obtain authentication or information within a certain period of time may also be limited. This avoids repeated or numerous attempts to otherwise obtain the authentication.

As another example, hackers may also attempt to self-generate the ciphertext and send it to Remote Processing Device 160. However, it is very difficult to obtain the correct fingerprint. Additionally, the methods disclosed herein, as well as the exemplary encryption mechanisms, make the ciphertext self-generation even more difficult by requiring the combination of the unique identifier c 601 and the non-constant and varying temporary serial number 644 (the current millisecond m).

In embodiments that prefer efficiency and or energy-efficient operations, the Y&C encryption method may also be integrated into the fingerprint feature acquisition process. Specifically, Portable Device 110 may calculate the encryption value (a+c)mod b=d while the device is acquiring the fingerprint features. In this way, many intermediate steps can be combined and therefore the speed and power saving can be effectively improved.

In addition to the systems and methods described above, the described embodiments may have various applications. In some exemplary embodiments, fingerprint authentication and swiping operations may be used in a portable or mobile device, including a cell phone with a swipe sensor. Users may up-scan or down-scan in lieu of inputting a password. Similarly, swiping a finger in different directions may result in different operations. For example, swiping a finger in an upward direction on the swipe sensor may cause a user device (e.g., a portable device, a smart phone, a PC, a tablet, a client device, etc.) to unlock or to perform a pre-configured or user-configured operation, or to register with another device, such as a server. Scanning the finger in a downward direction on the swipe sensor may cause a user device to perform other operations, such as to download a file, to play music, to redial a recently-called number, or to go to email or other applications.

Using a finger as an authentication mechanism may simplify registration procedures and avoid problems associated with lost passwords, hacked passwords, etc. One embodiment can involve implementing fingerprint swiping with a portable device such as a smart phone or a touchpad. For example, a portable device running Google's Android®, Apple's iOS®, and other operation systems, as well as one or more applications on such device, may be configured, programmed, or designed to perform certain operations based on certain fingerprint swiping inputs.

In one embodiment, fingerprint swipe sensor hardware may be built or integrated into a portable device, such as a mobile phone. For the device's operation system (such as Android®), fingerprint input may be added as an input item under a security setting (or any other appropriate setting, depending on the operation system) to collect fingerprint data. The collected fingerprint data can be used for security purposes, such as to unlock the device or to log on to a phone or data access network.

FIG. 12 illustrates a flowchart of an exemplary method 700 for an apparatus to register a user's fingerprint features consistent with the disclosed embodiments. The apparatus may be any one of Portable Device 110 or Remote Processing Device 160. In one embodiment, a user may first enter desired security settings (702). The user may then swipe the finger for the first time (704) and for a second time (705). At step 706, the two fingerprint inputs are then compared to ensure correct capturing of the fingerprint features. If the fingerprint or fingerprint features are not matched, fingerprint data input steps 704 and 705 are repeated. If the fingerprint or fingerprint features are matched, the user then enters a password as a fail-safe in the event a fingerprint cannot be recognized in the future (707). The registration process may then complete (709).

After the fingerprint registration process completes, a portable device (such as a smart phone) may be unlocked when a user perform a pre-configured finger swiping operation, which may replace the traditional process of entering a password. In some embodiments, a user may use different fingerprint swiping directions to cause different operations of a device, such as entering into or waking up from a power saving, sleep, hibernation or other modes. In one example, swiping a finger in an upward direction may cause a device to wake up, and swiping the finger in a downward direction may cause the device to enter into a sleep mode or some other modes or bring up a menu or application for a user to select or operate from.

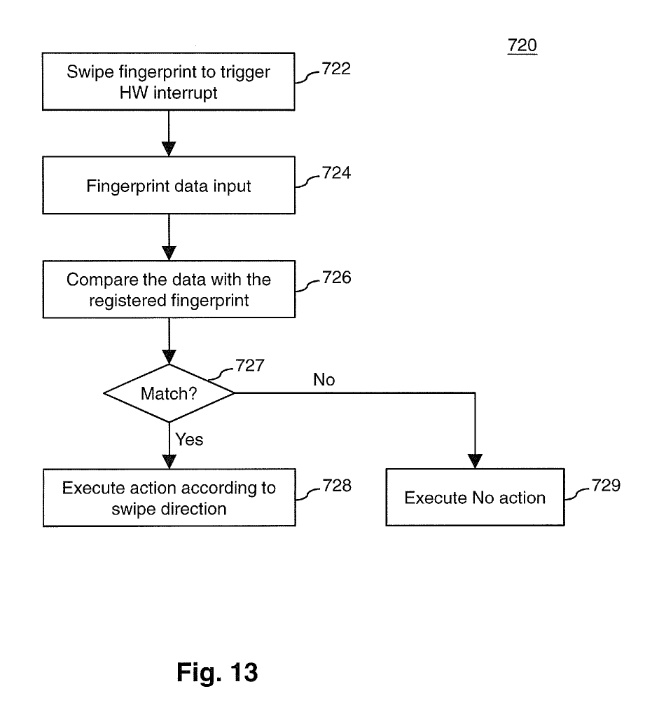

FIG. 13 illustrates a flowchart of exemplary method 720 for an apparatus to compare the input fingerprint features with the registered fingerprint features consistent with the disclosed embodiments. The apparatus may be any one of Portable Device 110 or Remote Processing Device 160. The apparatus compares the user fingerprint input (724) with the registered fingerprint (726). If a match is found (727), the apparatus execute an action according to swipe direction (728). If no match is found, the apparatus execute no action (729).

For a finger swiping or control application implemented on a portable device such as a smart phone, it may be desirable to use smallest data size or compressed data size for storing the registries or fingerprint data. It may also be desirable to complete fingerprint comparison in a very short time. Furthermore, different fingerprint swiping directions may cause different operations of a device, such as entering into or waking up from a power saving, sleep, hibernation or other modes.

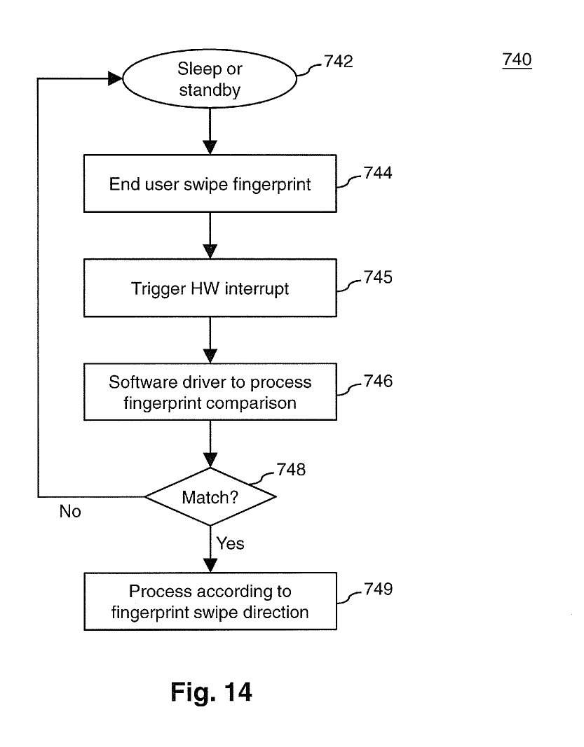

FIG. 14 illustrates a flowchart of an exemplary method 740 for an apparatus to either wake up a portable device or put the device back to sleep or standby mode depending on fingerprint match consistent with the disclosed embodiments. Portable Device 110 may initially be in sleep or standby mode (742). A user may swipe his/her finger in attempt to wake up the device (744). The user's swiping action may trigger a hardware interrupt in the portable device (745). A software driver may then proceed to process fingerprint comparison (746). If a match is found (748), Portable Device 110 wakes up and a predefined action may also be executed depending on the swiping direction (749). However, if no match is found, the portable device may go back to sleep or standby mode (742).

In another exemplary embodiment, fingerprint authentication and swiping-resulting operations may be used in Near Field Communication (NFC) Transaction. A user may scan his/her fingerprint to secure a transaction. For example, if a payment is made through an NFC device with built-in fingerprint authentication, the transaction can be protected from fraudulent use. Even if this NFC built-in device is lost, payment cannot be made by others because fingerprint authentication would fail.

In some embodiments, a portable device may have a fingerprint sensor as well as other devices including an RFID (Radio Frequency Identification) device or other NFC devices. When a user of a portable device engages in certain non-contact transactions by using a RFID device or other NFC devices, the transactions can be protected by fingerprint authentication. Thus, unauthorized transactions can be prevented even when a device is lost or stolen. Fingerprint authentication can be implemented on various portable devices, such as PDAs, mobile phones, portable gaming devices, notebook/laptop PCs, netbooks, various other consumer products, etc.

In another embodiment, an NFC device may be combined with a fingerprint sensor to form a single operating device. For example, fingerprint sensor may be embedded within a credit card, a door entry key/fob/token, a badge, or other devices.

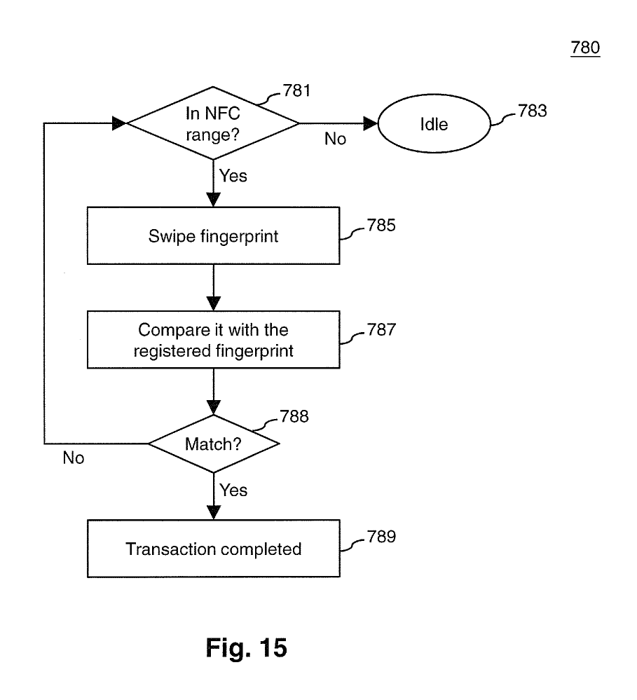

FIG. 15 illustrates a flowchart of exemplary method 780 for an apparatus to authenticate transactions made through Near Field Communication devices based on fingerprint features consistent with the disclosed embodiments. The apparatus may first detect whether an NFC device is in range (781). If an NFC device is detected and a transaction is initiated, the apparatus may prompt user to swipe finger over the fingerprint sensor (785). The apparatus may then compare the captured fingerprint features with a pre-registered fingerprint (787). If a match is found (788), the transaction may then proceed and complete (789). If a match is not found (788), apparatus repeats steps 781 and 785-788. The apparatus may also be configured to refuse further authentication attempts and put the system to idle after a predefined number of attempts have been reached (783). The system may also be set to idle if no NFC is in range (783).

The described embodiments may also be used in dialing applications in phones. FIG. 16 illustrates a flowchart of exemplary method 800 for an apparatus to register a user's fingerprint features for an exemplary fast dialing application consistent with the disclosed embodiments. In an exemplary registration process 800, the apparatus first requests fingerprint input from a user (803). The user can swipe the finger across a fingerprint sensor/reader to enter the fingerprint. The apparatus encodes and records the fingerprint and the swipe direction (804). The apparatus then requests the user to input desired fast-dialing information including the contact's name and corresponding phone number (805). After the fast-dial information was entered, the apparatus combines fingerprint data with the fast-dial information (807) and stores the combined information into a database (808). The fast-dialing registration process completes (809).

FIG. 17 illustrates a flowchart of exemplary method 820 for an apparatus to implement an exemplary fingerprint-based fast dialing application consistent with the disclosed embodiments. In an exemplary dialing process 820, the user is presented with a dialing menu (821). The apparatus may activate the fingerprint swipe sensor (823). The user may swipe his/her or her finger across the sensor in a certain direction (824). The apparatus encodes the fingerprint and records the swipe direction (825). The apparatus compares a fingerprint and swipe direction with the pre-registered fast-dial information stored in the database (826). If a match is found, the apparatus sends the corresponding phone number and issues a dialing command (828). If a match is not found, the apparatus issues a failure indication to the user (829).

As another example, the described embodiments may be implemented to provide or support online shopping applications. FIG. 18 illustrates a flowchart of exemplar method 830 for an apparatus to execute different commands corresponding to different swiping directions consistent with the disclosed embodiments. In an exemplary online shopping process, steps 831-836 are similar to steps 742-749 in FIG. 14. At step 837, if the swiping direction is towards the left, the apparatus may execute a command to keep the selected goods in the cart for consideration to buy later (838A). If the swiping direction is towards the right, the apparatus may execute a command to proceed to rent the goods instead (838B). If the swiping direction is upward, the apparatus may execute a command to proceed to login (839A). If the swiping direction is downward, the apparatus may execute a command to proceed to buy the goods (839B). It is understood by those skilled in the art that the directions and corresponding actions executed are exemplary only and may be any other directions or actions.

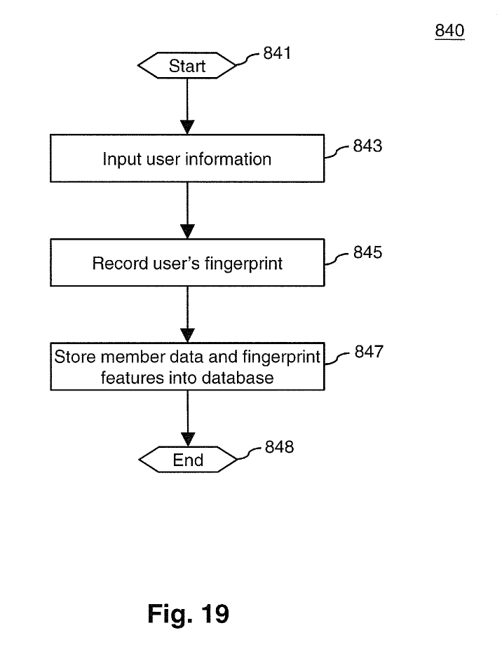

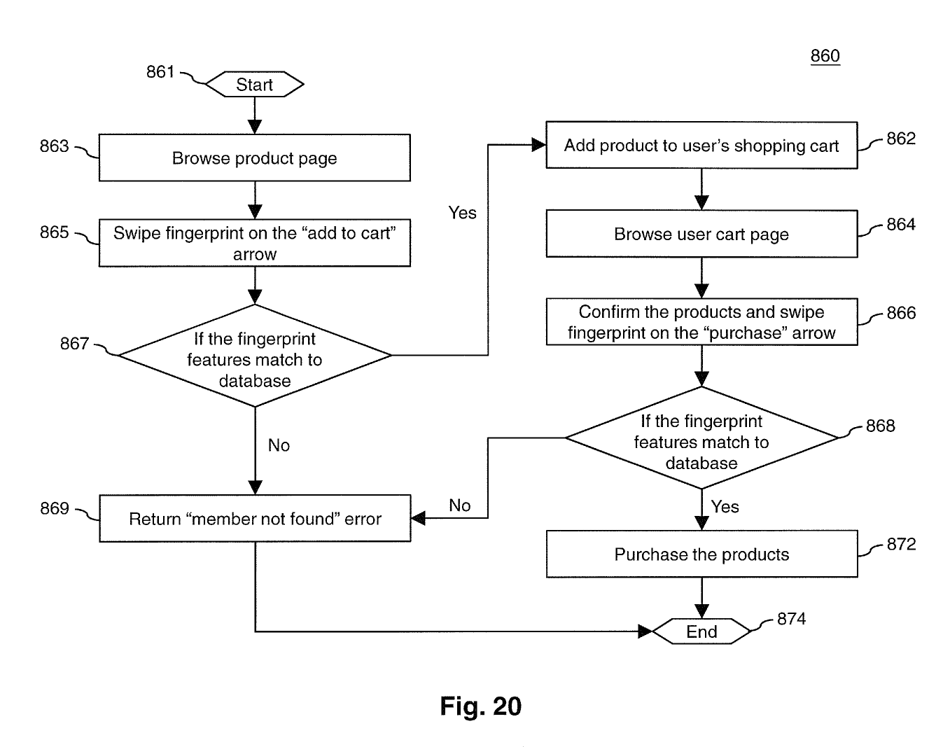

FIG. 19 illustrates a flowchart of exemplary method 840 of an apparatus to register a user's fingerprint features for an exemplary online shopping application consistent with the disclosed embodiments. Initially, users may register their membership info (e.g. credit card) and their fingerprints (843). The apparatus then records the users' fingerprints (845) and stores their membership data and fingerprint features into a database (847). Once a user registers his/her information, he/she can start shopping, as illustrated by FIG. 20.

FIG. 20 illustrates a flowchart of an exemplary method 860 for an apparatus to implement an exemplary fingerprint-based online shopping application consistent with the disclosed embodiments. The user browses the products (863) and swipes his/her finger on the “add to cart” arrow when a desired product is found (865). The apparatus compares the fingerprint features to those stored in the database (867). If a match is found, the product is added to the user's online shopping cart (862). The user may repeat this process until he/she adds all the products into the cart. Before purchasing, the user may browse the entire shopping cart (864). The user then confirms the products in the cart and swipes his/her finger on the “purchase” arrow (866). If the fingerprint features match those stored in the database (868), the apparatus issues a command to purchase the products in the cart (872). If no match is found during either of the fingerprint match step 867 or 868, the apparatus returns with a “member not found” error (869).

Because the user authentication may be made by Remote Processing Device 160 based on the user's fingerprint or fingerprint features, a user may avoid the need to login with his/her account name or password. Because the user is the only person with the matching fingerprint features, the transaction is secure and an unauthorized purchase attempted by others can be blocked even if the purchase is attempted by using the authorized user's device. The authentication can also be used for online stock brokerages, online banking, etc. As illustrated above, finger-swiping in different directions may result in different operations.

As another example, network access, registration, or authentication may also involve one or more of the methods and systems described in the embodiments illustrated above. In an exemplary embodiment relating to network access or registration, swiping a finger in different directions may result in different operations. For example, scanning a finger in an upward direction on the swipe sensor may cause a user device (a portable device, a smart phone, a PC, a tablet, a client device, etc.) to register with another device, such as a server. Scanning the finger in a downward direction on the swipe sensor may cause the user device to perform other operations, such as to download a file, to play music, to redial a recently-called number, or to access email or other applications. Using a finger as an authentication mechanism may simplify registration procedures and avoid problems relating to lost passwords, hacked passwords, etc.

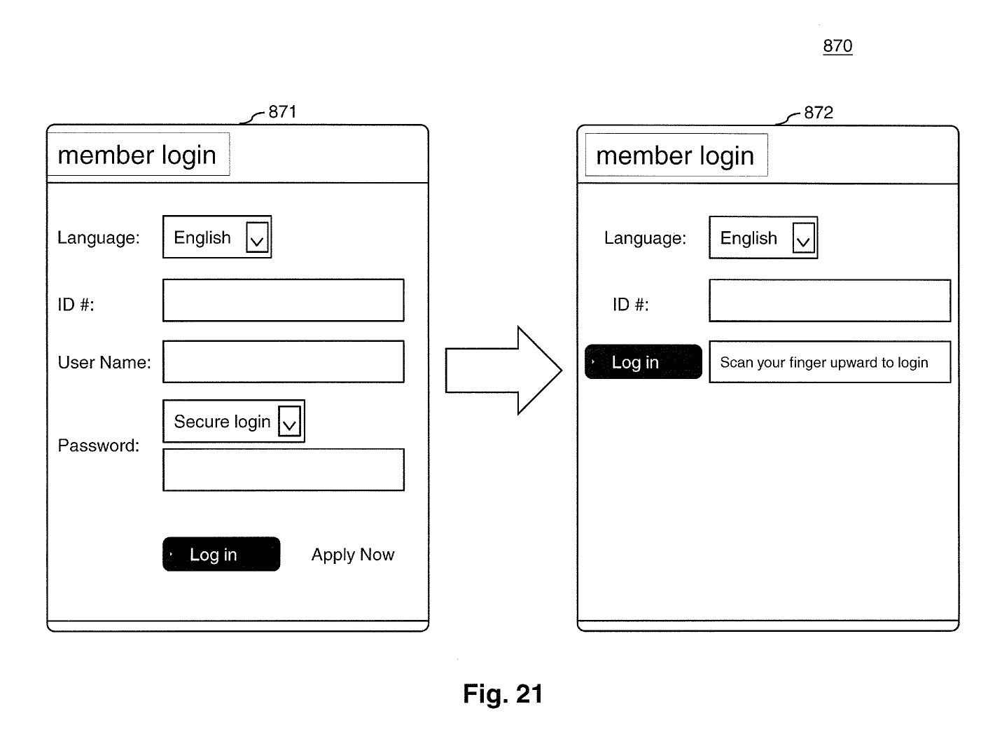

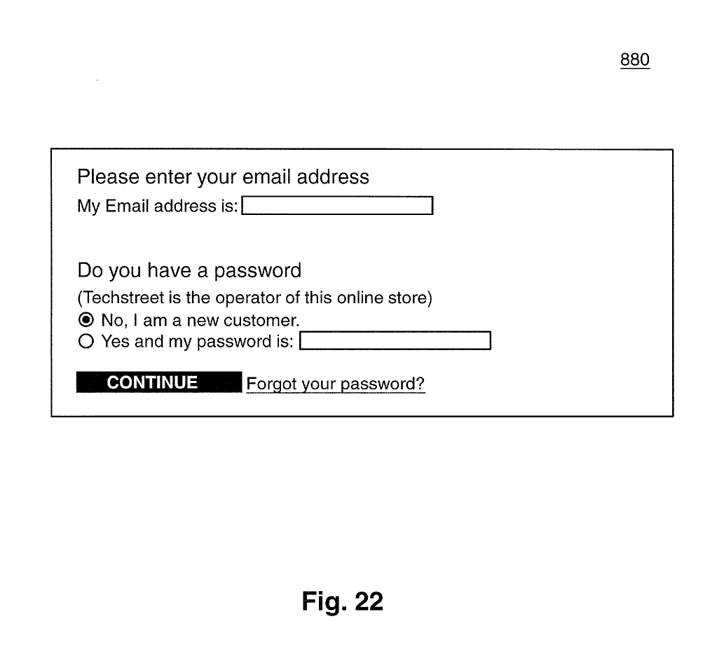

FIG. 21 illustrates exemplary screen captures 870 of the online access interface for using fingerprint in lieu of user ID and/or password. In a traditional online login process, as an authentication process, the system typically requires a user to input his/her ID#, user name and password (871). However, login based on fingerprint swiping direction greatly simplify the process. As shown in 872, a simple swiping of a user's finger upwards may be used to substitute input of user name and password and may result in logging into the website. FIG. 22 illustrates another exemplary screen capture 880 of traditional login interface, which may be easily converted or configured to accept a fingerprint as an alternative to user ID and/or password.

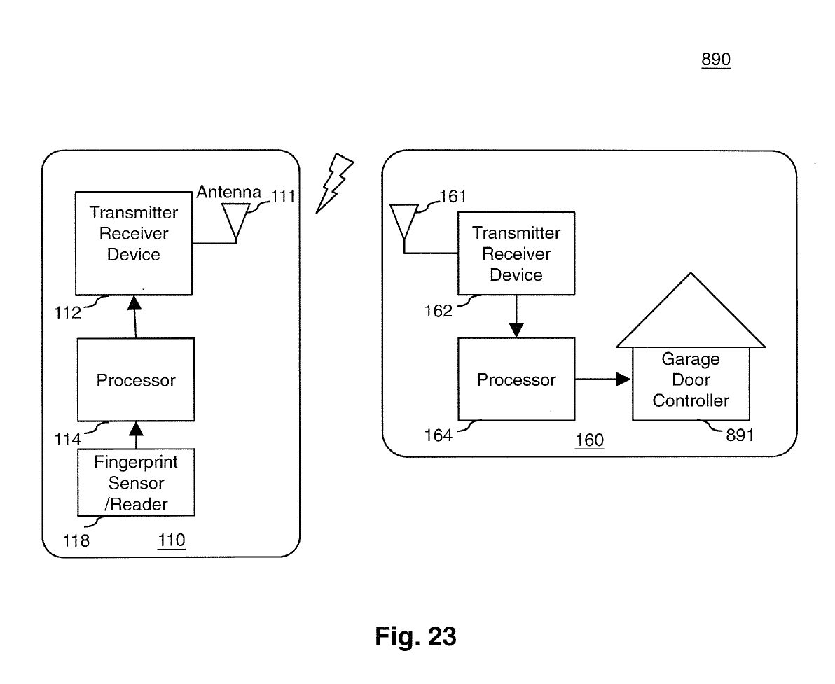

As another example, the described embodiments may be implemented to effect the remote control of a garage door. FIG. 23 illustrates an exemplary embodiment of a fingerprint based remote control of a garage door system (890). In an exemplary embodiment related to a garage-door opener, swiping a finger in different directions may result in different operations. In some exemplary embodiments, Portable Device 110 includes Fingerprint Sensor/Reader 118. A user swipes his/her finger over Fingerprint Sensor/Reader 118 and inputs the fingerprint. Processor 114 provides the fingerprint features, which may be transmitted to Remote Processing Device 160 through Transmitter/Receiver Device 112 such as a RF (Radio Frequency) transmitter with Antenna 111. Transmitter Receiver Device 162 with Antenna 161 receives the fingerprint features and passes onto Processor 164. If a fingerprint match is found, Processor 164 compares the fingerprint features and executes different commands according to different swiping direction. For example, scanning a finger on the swipe sensor in an upward direction may cause Garage Door Controller 891 to issue an “open” command, while scanning the finger on the swipe sensor in a downward direction may cause Garage Door Controller 891 to issue a “close” command.

It will be appreciated by those skilled in the art that changes, modifications, variations, and/or adjustments can be made to the disclosed embodiments described above without departing from the concepts or examples disclosed herein. Therefore, the disclosed embodiments are not limited to the particular details disclosed, but are intended to cover changes, modifications, variations, and/or adjustments consistent with the spirit and scope of the disclosed embodiments as described by the claims that follow.

What is claimed is:

1. A method for operating a system based on fingerprint scanning inputs, comprising:
receiving, by a fingerprint sensor, a fingerprint input;
providing, from a processor coupled with the fingerprint sensor, fingerprint feature data representing features of the fingerprint input;
executing a first command, by the processor, if comparing the fingerprint feature data with at least a portion of stored fingerprint data results in a first match reflecting that the fingerprint input occurred in a first direction;
executing a second command that is different from the first command, by the processor, if comparing the fingerprint feature data with the at least a portion of the stored fingerprint data results in a second match reflecting that the fingerprint input occurred in a second direction; and
executing a third command, by the processor, if comparing the fingerprint feature data with the at least a portion of the stored fingerprint data results in a non-match.

2. The method of claim 1, wherein the processor comprises a processor in one of a smart phone, a cellular phone, a PDA, a tablet PC, a electronic book reader, a laptop computer, an ultrabook, a netbook, and a personal computer.

3. The method of claim 1, wherein the stored fingerprint data comprise stored fingerprint feature data reflecting a first set of features corresponding to a first finger-scanning direction and a second set of features corresponding to a second finger-scanning direction, wherein the first match corresponds to a feature match between the fingerprint feature data and the first set of features, and the second match corresponds to a feature match between the fingerprint feature data and the second set of features.

4. The method of claim 1, wherein the first direction is substantially opposite to the second direction, and the first direction is a substantially-horizontal direction or a substantially-vertical direction.

5. The method of claim 1, wherein the fingerprint feature data are transmitted to a remote processing device, for comparison by the remote processing device, in an encoded format based on a fixed code associated with a portable device containing the processor and based on at least one temporary code provided by at least one of the processor and the remote processing device.

6. The method of claim 5, wherein an encoding of the fingerprint feature data comprises:
identifying, by the processor, the fixed code associated with a client device having the processor;
receiving the temporary code from the remote processing device;
storing the fixed code and the temporary code in a memory device of the client device; and
encoding the fingerprint feature data, by the processor, based on the fixed code and the temporary code.

7. The method of claim 1, wherein comparing the fingerprint feature data with the at least a portion of the stored fingerprint data comprises comparing, by at least one of the processor and a remote processing device coupled with the processor, the fingerprint feature data to the at least a portion of the stored fingerprint data.

8. The method of claim 1, wherein the processor receives the first match from a remote processing device, and the first command comprises displaying contents comprising information from the remote processing device or executing a user-device command received from the remote processing device.

9. A method for enabling fingerprint-based operation of a client device, comprising:
identifying, by a remote processing device, a fixed code associated with the client device receiving a fingerprint input;
identifying, by the remote processing device, a temporary code associated with the client device, the temporary code being provided by one of the client device and the remote processing device;
transmitting the temporary code from the remote processing device to the client device if the temporary code is provided by the remote processing device;
receiving encrypted fingerprint feature data from the client device, the encrypted fingerprint feature data being reflective of fingerprint feature data representing features of the fingerprint input and having been encoded based on the fixed code and the temporary code; and
decoding the encrypted fingerprint feature data using the fixed code and the temporary code.

10. The method of claim 9, further comprising:
comparing, by the remote processing device, decoded fingerprint feature data with at least a portion of stored fingerprint data; and
informing the client device of a first match if the fingerprint feature data being compared result in the first match reflecting that the fingerprint input occurred in a first direction;
informing the client device of a second match if the fingerprint feature data being compared result in the second match reflecting that the fingerprint input occurred in a second direction; and
informing the client device of a non-match if the fingerprint feature data being compared result in the non-match reflecting that the fingerprint input is unable to be matched to stored fingerprint data.

11. The method of claim 9, further comprising:
comparing, by the remote processing device, decoded fingerprint feature data with at least a portion of stored fingerprint data; and
executing a first command, by the remote processing device, if the fingerprint feature data being compared result in a first match reflecting that the fingerprint input occurred in a first direction;
executing a second command, by the remote processing device, if the fingerprint feature data being compared result in a second match reflecting that the fingerprint input occurred in a second direction; and
executing a third command, by the remote processing device, if the fingerprint feature data being compared result in a non-match.

12. A system for implementing fingerprint-based operations, comprising:
an input interface for receiving, by a fingerprint sensor, a fingerprint input;
a processor coupled with the input interface, the processor being configured to provide fingerprint feature data representing features of the fingerprint input, the processor further being configured to execute a first command if comparing the fingerprint feature data with at least a portion of stored fingerprint data results in a first match reflecting that the fingerprint input occurred in a first direction and to execute a second command that is different from the first command if comparing the fingerprint feature data with the at least a portion of the stored fingerprint data results in a second match reflecting that the fingerprint input occurred in a second direction; and
a storage device coupled with the processor for storing at least one of the fingerprint data, the first command, and the second command.

13. The system of claim 12, wherein the system comprises a smart phone, a cellular phone, a PDA, a tablet PC, a electronic book reader, a laptop computer, an ultrabook, a netbook, and a personal computer.

14. The system of claim 12, further comprising a display device coupled with the processor for displaying an indication to a user based on at least one of the first match and the second match.

15. The system of claim 12, wherein the processor is further configured to execute a third command if comparing the fingerprint feature data with the at least a portion of the stored fingerprint data results in a non-match.

16. The system of claim 12, wherein the stored fingerprint data comprise stored fingerprint feature data reflecting a first set of features corresponding to a first finger scanning direction and a second set of features corresponding to a second finger scanning direction, wherein the first match corresponds to a feature match of between the fingerprint feature data and the first set of features, and the second match corresponds to a feature match between the fingerprint feature data and the second set of features.

17. The system of claim 12, further comprising a transmission interface coupled with the processor for transmitting the fingerprint feature data in an encrypted form to a remote processing device.

18. The system of claim 17, wherein the fingerprint feature data in the encrypted form are encoded based on a fixed code associated with the system and at least one temporary code provided by at least one of the system and a remote processing device.

19. A non-transitory computer readable medium comprising instructions for implementing fingerprint-based operations, wherein the instructions comprising program code, the program code being operable, when executed by a device, to cause the device to perform a method comprising:
receiving, by a fingerprint sensor, a fingerprint input;
providing, by a processor, fingerprint feature data representing features of the fingerprint input;
comparing, by at least one of the processor and a remote processing device, the fingerprint feature data to at least a portion of a stored fingerprint data;
executing a first command, by the processor, if the fingerprint feature data being compared result in a first match reflecting that the fingerprint input occurred in a first direction;
executing a second command, by the processor, if the fingerprint feature data being compared result in a second match reflecting that the fingerprint input occurred in a second direction; and
executing a third command, by the processor, if the fingerprint feature data being compared result in a non-match.

20. The non-transitory computer readable medium of claim 19, wherein the instructions for implementing the fingerprint-based operations reside in a memory of the device, and the device comprises one of a smart phone, a cellular phone, a PDA, a tablet PC, a electronic book reader, a laptop computer, an ultrabook, a netbook, and a personal computer.

21. The non-transitory computer readable medium of claim 19, wherein the instructions for implementing the fingerprint-based operations cause the device to transmit the fingerprint feature data in an encoded format based on a fixed code associated with a portable device and at least one temporary code provided by at least one of the processor and the remote processing device.

22. The non-transitory computer readable medium of claim 21, wherein an encoding of the fingerprint feature data comprises:
identifying the fixed code associated a client device;
identifying the temporary code from one of the client device and the remote processing device;
storing the fixed code and the temporary code in a database; and
encoding the fingerprint feature data based on the fixed code and the temporary code.
